(19) United States
(12) Patent Application Publication
(10) Pub. No.: US 2026/0292910 A1
(43) Pub. Date: Sep. 24, 2026

(54) METHOD OF REMOTE USER EQUIPMENT (UE), METHOD OF FIRST COMMUNICATION APPARATUS, REMOTE UE AND FIRST COMMUNICATION APPARATUS

(71) Applicant: NEC Corporation, Tokyo (JP)

(72) Inventors: Toshiyuki TAMURA, Ibaraki (JP); Prabhu KALIYAMMAL THIRUVASAGAM, San Diego, CA (US)

(73) Assignee: NEC Corporation, Tokyo (JP)

(21) Appl. No.: 19/474,292

(22) PCT Filed: Apr. 11, 2024
(86) PCT No.: PCT/JP2024/014604

§ 371 Date: Oct. 10, 2025

(30) Foreign Application Priority Data
Apr. 27, 2023 (IN) 202311030373

(51) Int. Cl. H04W 76/15; H04W 4/80; H04W 60/00; H04W 88/04

(52) U.S. Cl. CPC H04W 76/15; H04W 4/80; H04W 60/00; H04W 88/04

(57) ABSTRACT

An aspect of this disclosure includes a method of a User Equipment (UE), the method includes communicating with a communication apparatus; and sending information to the communication apparatus, wherein the information indicates that the UE supports communication via a plurality of Proximity based Services (ProSe) UE-to-Network Relays.

### TECHNICAL FIELD

The present disclosure relates to a method of a Remote User Equipment (UE), a method of a first communication apparatus, a Remote UE and a first communication apparatus etc.

### BACKGROUND ART

According to the 3GPP TS 22.261 (NPL 2), the following service requirement is described. This requirement is important for the remote UE(s) for maintaining stable indirect network connection by extending coverage in a case where the Remote UE(s) moves since a coverage provided by each Network Relay UE(s) is relatively narrow comparing to a coverage of a regular radio station.
The 5G system shall be able to manage communication between a remote UE and the 5G network across multi-path indirect network connections.

### CITATION LIST

### Non Patent Literature

NPL 1: 3GPP TR 21.905: “Vocabulary for 3GPP Specifications”. V17.1.0 (2021-12)
NPL 2: 3GPP TS 22.261: “Service requirements for the 5G system Stage 1”. V19.2.0 (2023-03)
NPL 3: 3GPP TS 23.501: “System architecture for the 5G System (5GS)”. V18.1.0 (2023-04)
NPL 4: 3GPP TS 23.502: “Procedures for the 5G System (5GS)”. V18.1.1 (2023-04)
NPL 5: 3GPP TS 23.503: “Policy and charging control framework for the 5G System (5GS) Stage 2”. V18.1.0 (2023-04)
NPL 6: 3GPP TS 24.501: “Non-Access-Stratum (NAS) protocol for 5G System (5GS) Stage 3”. V18.2.1 (2023-04)
NPL 7: 3GPP TS 23.304: “Proximity based Services (ProSe) in the 5G System (5GS)”. V18.1.0 (2023-04)
NPL 8: 3GPP TS 37.340: “Multi-connectivity Stage 2”. V17.4.0 (2023-03)

### SUMMARY OF INVENTION

### Technical Problem

However, the following service requirement has not been supported by the 5GS yet. For example, there is no mechanism in the 3GPP specification(s) for achieving the following service requirement.
The 5G system shall be able to manage communication between a remote UE and the 5G network across multi-path indirect network connections.

If the 5GS does not support the multi-path for indirect network connections, the Remote UE (or the remote UE) cannot avoid a sudden disruption or disconnection for any connectivity services over the indirect network connection due to unstable communication over single connection between the Remote UE and the Network Relay UE. User experience for the indirect network connection suffers from an unstable connection over single connection between the Remote UE and the Network Relay UE.

In order to mitigate or avoid a sudden disruption or disconnection over the indirect network connection, multi-path for indirect network connections using multiple Network Relay UEs is required.

### Solution to Problem

In a first example aspect, a method of a Remote User Equipment (UE) includes: performing a registration procedure; and performing a Protocol Data Unit (PDU) Session establishment procedure via a first ProSe UE-to-Network Relay and a PDU Session establishment procedure via a second ProSe UE-to-Network Relay.

In a second example aspect, a method of a first communication apparatus includes:
receiving information indicating that a Remote User Equipment (UE) supports connection via a first ProSe UE-to-Network Relay and connection via a second ProSe UE-to-Network Relay; and
sending information indicating that the Remote UE is allowed to perform communication via the first ProSe UE-to-Network Relay and via the second ProSe UE-to-Network Relay.

In a third example aspect, a method of a first communication apparatus includes:
communicating with a second communication apparatus; and
sending, to the second communication apparatus, information indicating that a Remote User Equipment (UE) is allowed to perform communication via a first ProSe UE-to-Network Relay and via a second ProSe UE-to-Network Relay.

In a fourth example aspect, a method of a first communication apparatus includes:
receiving, from a second communication apparatus, information indicating that a Remote User Equipment (UE) requests communication via a first ProSe UE-to-Network Relay and via a second ProSe UE-to-Network Relay; and
sending information for controlling the communication to the second communication apparatus.

In a fifth example aspect, a method of a first communication apparatus includes:
receiving information for controlling communication via a first ProSe UE-to-Network Relay and via a second ProSe UE-to-Network Relay; and
performing the communication based on the information.

In a sixth example aspect, a method of a first communication apparatus includes:
receiving, from a second communication apparatus, information indicating that a Remote User Equipment (UE) requests communication via a first ProSe UE-to-Network Relay and via a second ProSe UE-to-Network Relay; and
sending, to the second communication apparatus, information indicating that the Remote UE is allowed to establish the communication.

In a seventh example aspect, a method of a first communication apparatus includes:
receiving, from a second communication apparatus, information indicating that a Remote User Equipment (UE) requests communication via a first ProSe UE-to-Network Relay and via a second ProSe UE-to-Network Relay and information indicating that the second communication apparatus supports the communication; and
sending, to the second communication apparatus, a policy including information indicating that the Remote UE is allowed to establish the communication.

In an eighth example aspect, a Remote User Equipment (UE) includes:
means for performing a registration procedure; and
means for performing a Protocol Data Unit (PDU) Session establishment procedure via a first ProSe UE-to-Network Relay and a PDU Session establishment procedure via a second ProSe UE-to-Network Relay.

In a ninth example aspect, a first communication apparatus includes:
means for receiving information indicating that a Remote User Equipment (UE) supports connection via a first ProSe UE-to-Network Relay and connection via a second ProSe UE-to-Network Relay; and
means for sending information indicating that the Remote UE is allowed to perform communication via the first ProSe UE-to-Network Relay and via the second ProSe UE-to-Network Relay.

In a tenth example aspect, a first communication apparatus includes:
means for communicating with a second communication apparatus; and
means for sending, to the second communication apparatus, information indicating that a Remote User Equipment (UE) is allowed to perform communication via a first ProSe UE-to-Network Relay and via a second ProSe UE-to-Network Relay.

5 In an eleventh example aspect, a first communication apparatus includes:
means for receiving, from a second communication apparatus, information indicating that a Remote User Equipment (UE) requests communication via a first ProSe UE-to-Network Relay and via a second ProSe UE-to-Network Relay; and
means for sending information for controlling the communication to the second communication apparatus.

In a twelfth example aspect, a first communication apparatus includes:
means for receiving information for controlling communication via a first ProSe UE-to-Network Relay and via a second ProSe UE-to-Network Relay; and
means for performing the communication based on the information.

In a thirteenth example aspect, a first communication apparatus includes:
means for receiving, from a second communication apparatus, information indicating that a Remote User Equipment (UE) requests communication via a first ProSe UE-to-Network Relay and via a second ProSe UE-to-Network Relay; and
means for sending, to the second communication apparatus, information indicating that the Remote UE is allowed to establish the communication.

In a fourteenth example aspect, a first communication apparatus includes:
means for receiving, from a second communication apparatus, information indicating that a Remote User Equipment (UE) requests communication via a first ProSe UE-to-Network Relay and via a second ProSe UE-to-Network Relay and information indicating that the second communication apparatus supports the communication; and
means for sending, to the second communication apparatus, a policy including information indicating that the Remote UE is allowed to establish the communication.

### Advantageous Effects of Invention

An example object of this disclosure is to provide a method and apparatus that can solve the above-mentioned problem.

### BRIEF DESCRIPTION OF DRAWINGS

FIG. 1 is a Network connection model of a First example of a First Aspect.

FIG. 2 is a Signaling diagram of a Second example of the First Aspect.

FIG. 3 is a Signaling diagram of a Third example of the First Aspect.

FIG. 4 is a Remote UE movement as an example for the First Aspect and the Second Aspect.

FIG. 5 is a Signaling diagram of a Fourth example of the First Aspect.

FIG. 6 is a Network connection model of a First example of a Second Aspect.

FIG. 7 is a Signaling diagram of a Third example of the Second Aspect.

FIG. 8 is a Signaling diagram of a Fourth example of the Second Aspect.

FIG. 9 is a diagram illustrating a system overview for Proximity based Services.

FIG. 10 is a block diagram illustrating a UE.

FIG. 11 is a block diagram illustrating an (R)AN node.

FIG. 12 is a diagram illustrating System overview of (R)AN node based on O-RAN architecture.

FIG. 13 is a block diagram illustrating an RU.

FIG. 14 is a block diagram illustrating a DU.

FIG. 15 is a block diagram illustrating a CU.

FIG. 16 is a block diagram illustrating an AMF.

FIG. 17 is a block diagram illustrating an SMF.

FIG. 18 is a block diagram illustrating an UPF.

FIG. 19 is a block diagram illustrating a PCF.

FIG. 20 is a block diagram illustrating an AF.

FIG. 21 is a block diagram illustrating a UDM.

### DESCRIPTION OF EMBODIMENTS

### Abbreviations

For the purposes of the present document, the abbreviations given in 3GPP TR 21.905 (NPL 1) and the following apply. An abbreviation defined in the present document takes precedence over the definition of the same abbreviation, if any, in 3GPP TR 21.905 (NPL 1).

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QOS Identifier |
| AF | Application Function |
| AMF | Access and Mobility Management Function |
| AMF-G | Geographically selected Access and Mobility Management Function |
| AMF-NG | Non-Geographically selected Access and Mobility Management |
| | Function |
| ANDSF | Access Network Discovery and Selection Function |
| ARFCN | Absolute radio-frequency channel number |
| AS | Access Stratum |
| ASN | Abstract Syntax Notation |
| ATSSS | Access Traffic Steering, Switching, Splitting |
| ATSSS-LL | ATSSS Low-Layer |
| AuC | Authentication Centre |
| AUSF | Authentication Server Function |
| AUTN | Authentication token |
| BCCH | Broadcast Control Channel |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| G-PDU | GTP encapsulated user Plane Data Unit |
| GPS | Global Positioning System |
| GPSI | Generic Public Subscription Identifier |
| GUAMI | Globally Unique AMF Identifier |
| GUTI | Globally Unique Temporary UE Identity |
| HPLMN | Home Public Land Mobile Network |
| HR | Home Routed (roaming) |
| HSS | Home Subscriber Server |
| IAB | Integrated access and backhaul |
| IPsec | Internet Protocol Security |
| IMEI/TAC | IMEI Type Allocation Code |
| IMSI | International Mobile Subscriber Identity |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| ME | Mobile Equipment |
| MFBR | Maximum Flow Bit Rate |
| MICO | Mobile Initiated Connection Only |
| MINT | Minimization of service interruption |
| MITM | Man In the Middle |
| MME | Mobility Management Entity |
| MN | Master Node |
| MNC | Mobile Network Code |
| MOCN | Multiple Operator Core Network |
| MPS | Multimedia Priority Service |
| MPTCP | Multi-Path TCP Protocol |
| MT | Mobile Termination |
| N3IWF | Non-3GPP InterWorking Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NMEA | National Marine Electronics Association |
| NPN | Non-Public Network |
| NR | New Radio |
| NSAG | Network Slice Access Stratum Group |
| NRF | Network Repository Function |
| NSAC | Network Slice Admission Control |
| NSACF | Network Slice Admission Control Function |
| NSI ID | Network Slice Instance Identifier |
| NSSAA | Network Slice-Specific Authentication and Authorization |
| NSSAAF | Network Slice-Specific Authentication and Authorization Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PCO | Protocol Configuration Options |
| PCRF | Policy and Charging Rules Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| ProSe | Proximity based Services |
| PSA | PDU Session Anchor |
| PTP | Precision Time Protocol |
| QFI | QoS Flow Identifier |
| QOE | Quality of Experience |
| RACS | Radio Capabilities Signalling optimisation |
| (R)AN | (Radio) Access Network |
| RAT | Radio Access Technology |
| RG | Residential Gateway |
| RIM | Remote Interference Management |
| RQA | Reflective QoS Attribute |
| RQI | Reflective QoS Indication |
| RRC | Radio Resource Control |
| RSC | Relay Service Code |
| RSD | Route Selection Descriptor |
| RSN | Redundancy Sequence Number |
| RSRP | Reference Signal Received Power |
| RSRQ | Reference Signal Received Quality |
| RVAS | Roaming Value Added Service |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SENSE | Signal Level Enhanced Network Selection |
| SEPP | Security Edge Protection Proxy |
| SGW | Serving Gateway |
| SIB | System Information Block |
| SINR | Signal to Interference plus Noise Ratio |
| SMF | Session Management Function |
| SMSF | Short Message Service Function |
| SN | Sequence Number |
| SN | Secondary Node |
| SN name | Serving Network Name. |
| SNPN | Stand-alone Non-Public Network |
| S-NSSAI | Single Network Slice Selection Assistance Information |
| SOR | Steering of Roaming |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TAU | Tracking Area Update |
| TEID | Tunnel Endpoint Identifier |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| UPSI | UE Policy Section Identifier |
| URLLC | Ultra Reliable Low Latency Communication |
| URRP-AMF | UE Reachability Request Parameter for AMF |
| URSP | UE Route Selection Policy |
| USIM | User Services Identity Module |
| VID | VLAN Identifier |
| VLAN | Virtual Local Area Network |
| VPLMN | Visited Public Land Mobile Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in 3GPP TR 21.905 (NPL 1) and the following apply. A term defined in the present document takes precedence over the definition of the same term, if any, in 3GPP TR 21.905 (NPL 1).

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects (i.e., the First Aspect, the Second Aspect, the First example of the First Aspect, the Second example of the First Aspect, the Third example of the First Aspect, the Fourth example of the First Aspect, the First example of the Second Aspect, the Second example of the Second Aspect, the Third example of the Second Aspect, the Fourth example of the Second Aspect, Variant of each Aspects) and elements included in the each of Aspects described below may be implemented independently or in combination with any other. These Aspects include novel characteristics different from one another. Accordingly, these Aspects contribute to achieving objects or solving problems different from one another and contribute to obtaining advantages different from one another.

Any lists described in following aspects include at least one parameter or multiple parameters.

An example object of this disclosure is to provide a method and apparatus that can solve the above-mentioned problem.

A method of a Remote User Equipment (UE) according to example aspect of this disclosure includes performing a registration procedure. The method includes performing a Protocol Data Unit (PDU) Session establishment procedure via a first ProSe UE-to-Network Relay and a PDU Session establishment procedure via a second ProSe UE-to-Network Relay.

A method of a first communication apparatus according to example aspect of this disclosure includes receiving information indicating that a Remote User Equipment (UE) supports connection via a first ProSe UE-to-Network Relay and connection via a second ProSe UE-to-Network Relay. The method includes sending information indicating that the Remote UE is allowed to perform communication via the first ProSe UE-to-Network Relay and via the second ProSe UE-to-Network Relay.

A method of a first communication apparatus according to example aspect of this disclosure includes communicating with a second communication apparatus. The method includes sending, to the second communication apparatus, information indicating that a Remote User Equipment (UE) is allowed to perform communication via a first ProSe UE-to-Network Relay and via a second ProSe UE-to-Network Relay.

A method of a first communication apparatus according to example aspect of this disclosure includes receiving, from a second communication apparatus, information indicating that a Remote User Equipment (UE) requests communication via a first ProSe UE-to-Network Relay and via a second ProSe UE-to-Network Relay. The method includes sending information for controlling the communication to the second communication apparatus.

A method of a first communication apparatus according to example aspect of this disclosure includes receiving information for controlling communication via a first ProSe UE-to-Network Relay and via a second ProSe UE-to-Network Relay. The method includes performing the communication based on the information.

A method of a first communication apparatus according to example aspect of this disclosure includes receiving, from a second communication apparatus, information indicating that a Remote User Equipment (UE) requests communication via a first ProSe UE-to-Network Relay and via a second ProSe UE-to-Network Relay. The method includes sending, to the second communication apparatus, information indicating that the Remote UE is allowed to establish the communication.

A method of a first communication apparatus according to example aspect of this disclosure includes receiving, from a second communication apparatus, information indicating that a Remote User Equipment (UE) requests communication via a first ProSe UE-to-Network Relay and via a second ProSe UE-to-Network Relay and information indicating that the second communication apparatus supports the communication. The method includes sending, to the second communication apparatus, a policy including information indicating that the Remote UE is allowed to establish the communication.

A Remote User Equipment (UE) according to example aspect of this disclosure includes at least one memory, and at least one hardware processor coupled to the at least one memory. The at least one hardware processor is configured to perform a registration procedure. The at least one hardware processor is configured to perform a Protocol Data Unit (PDU) Session establishment procedure via a first ProSe UE-to-Network Relay and a PDU Session establishment procedure via a second ProSe UE-to-Network Relay.

A first communication apparatus according to example aspect of this disclosure includes at least one memory, and at least one hardware processor coupled to the at least one memory. The at least one hardware processor is configured to receive information indicating that a Remote User Equipment (UE) supports connection via a first ProSe UE-to-Network Relay and connection via a second ProSe UE-to-Network Relay. The at least one hardware processor is configured to send information indicating that the Remote UE is allowed to perform communication via the first ProSe UE-to-Network Relay and via the second ProSe UE-to-Network Relay.

A first communication apparatus according to example aspect of this disclosure includes at least one memory, and at least one hardware processor coupled to the at least one memory. The at least one hardware processor is configured to communicate with a second communication apparatus. The at least one hardware processor is configured to send, to the second communication apparatus, information indicating that a Remote User Equipment (UE) is allowed to perform communication via a first ProSe UE-to-Network Relay and via a second ProSe UE-to-Network Relay.

A first communication apparatus according to example aspect of this disclosure includes at least one memory, and at least one hardware processor coupled to the at least one memory. The at least one hardware processor is configured to receive, from a second communication apparatus, information indicating that a Remote User Equipment (UE) requests communication via a first ProSe UE-to-Network Relay and via a second ProSe UE-to-Network Relay. The at least one hardware processor is configured to send information for controlling the communication to the second communication apparatus.

A first communication apparatus according to example aspect of this disclosure includes at least one memory, and at least one hardware processor coupled to the at least one memory. The at least one hardware processor is configured to receive information for controlling communication via a first ProSe UE-to-Network Relay and via a second ProSe UE-to-Network Relay. The at least one hardware processor is configured to perform the communication based on the information.

A first communication apparatus according to example aspect of this disclosure includes at least one memory, and at least one hardware processor coupled to the at least one memory. The at least one hardware processor is configured to receive, from a second communication apparatus, information indicating that a Remote User Equipment (UE) requests communication via a first ProSe UE-to-Network Relay and via a second ProSe UE-to-Network Relay. The at least one hardware processor is configured to send, to the second communication apparatus, information indicating that the Remote UE is allowed to establish the communication.

A first communication apparatus according to example aspect of this disclosure includes at least one memory, and at least one hardware processor coupled to the at least one memory. The at least one hardware processor is configured to receive, from a second communication apparatus, information indicating that a Remote User Equipment (UE) requests communication via a first ProSe UE-to-Network Relay and via a second ProSe UE-to-Network Relay and information indicating that the second communication apparatus supports the communication. The at least one hardware processor is configured to send, to the second communication apparatus, a policy including information indicating that the Remote UE is allowed to establish the communication.

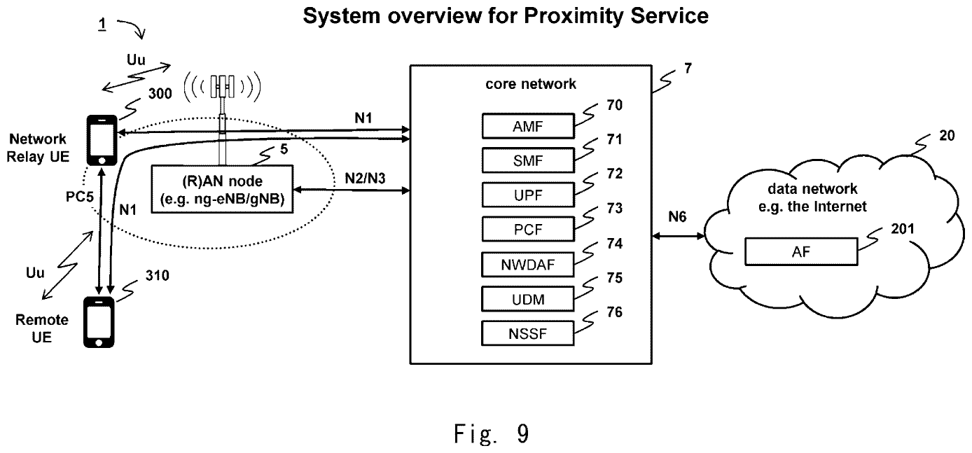

As this disclosure uses the System overview for Proximity based Services (ProSe) in FIG. 9 for disclosing the Aspect(s) below, a target service server for the Remote UE 310 to communicate with is an AF 201 in a data network 20. However, the target service server for the Remote UE 310 is not limited to the AF 201. For example, the target service server can be any server in the Internet, IMS, IoT service, V2X service and etc. For example, if disclosures in the Aspect(s) apply to the 5G ProSe Layer-3 UE-to-Network Relay with N3IWF support as described in 3GPP TS 23.304 (NPL 7), the target service server may be located in the Home PLMN of the Remote UE 310 and connected through N3IWF while the Remote UE 310 is in a Visited PLMN.

The Remote UE may be expressed as for example, ProSe Remote UE, 5G ProSe Remote UE etc.

The Network Relay UE may be expressed as for example, ProSe UE-to-Network Relay, 5G ProSe UE-to-Network Relay etc.

The Remote UE may establish the indirect network connection with Network Relay UEs using multiple Network Relay UEs.

### (First Aspect)

This aspect discloses mechanisms to configure multi-path for indirect network connections using multiple Network Relay UEs by adapting an enhanced Access Traffic Steering, Switching, Splitting (ATSSS) functionality. The multi-path for indirect network connections may be expressed as multi-path indirect network connections, multi-path indirect communication connections, multiple indirect network communication paths etc. Communication in the multi-path for indirect network connections or communication performed in the multi-path for indirect network connections may be expressed as multi-path indirect network communication.

The multi-path indirect communication connections provide high resiliency for data connectivity (e.g., data connectivity can be maintained for Remote UEs in a case where Remote UEs become out of coverage from a connected single Network Relay UE.).

### First Example of the First Aspect

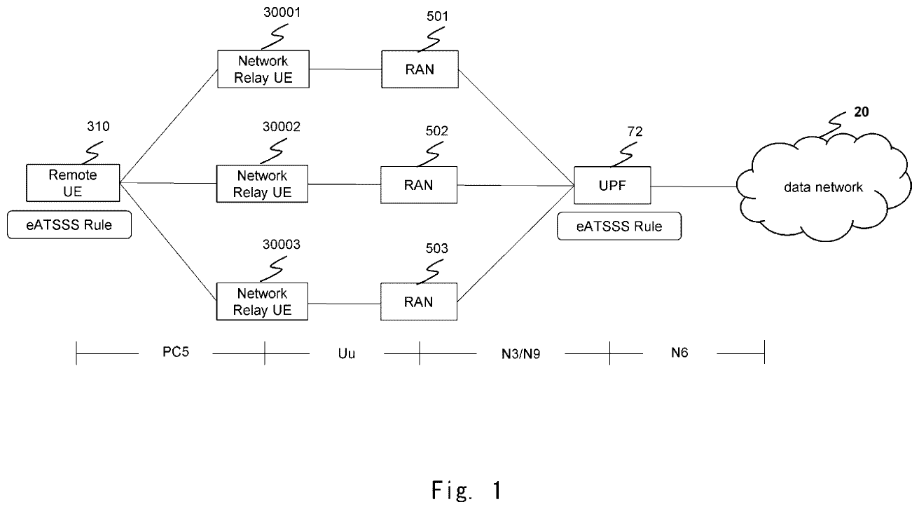

FIG. 1 includes a network connection model that supports the multi-path indirect network connections by adapting an enhanced Access Traffic Steering, Switching, Splitting (ATSSS) functionality to the 5GS supporting the Proximity based Services. Note that the ATSSS functionality is defined in the 3GPP TS 23.501 (NPL 3). The enhanced Access Traffic Steering, Switching, Splitting (eATSSS) functionality may be an enhancement of the ATSSS functionality.

FIG. 1 includes the network connection model that supports the multi-path indirect network connections by adapting the enhanced Access Traffic Steering, Switching, Splitting (ATSSS) functionality.

The Remote UE 310 connects to a Network Relay UE 30001, a Network Relay UE 30002 and a Network Relay UE 30003 for single enhanced Multi Access-PDU (MA PDU) Session. The MA PDU session is defined in 3GPP TS 23.501 (NPL 2) and 3GPP TS 23.502 (NPL 3). For example, the Remote UE 310 may connect to at least two Network Relay UEs.

While a Multi Access-PDU (MA PDU) Session is a PDU Session associated with two independent N3/N9 tunnels between a UPF 72 and a RAN 5 and with multiple access types, i.e., with one 3GPP access and one non-3GPP access both connected to 5GC according to 3GPP TS 23.502 (NPL 3), the enhanced Multi Access-PDU (MA PDU) Session may have two or more independent Uu connections between the Network Relay UEs 30 and RANs 5 and N3/N9 tunnels between the UPF 72 and RANs 5 with single access type, i.e., among 3GPP accesses or with multiple access types, i.e., with one or some 3GPP accesses and one or some non-3GPP accesses.

For example, the enhanced Multi Access-PDU (MA PDU) Session may be PDU Session(s) having or associated with two or more independent Uu connections between the Network Relay UEs 30 and RANs 5, and having or associated with N3/N9 tunnels between the UPF 72 and RANs 5, and associated with single access type, i.e., with some 3GPP accesses (or some non-3GPP accesses) or with multiple access types, i.e., with one or some 3GPP accesses and one or some non-3GPP accesses.

Although FIG. 1 illustrates that each Network Relay UE 30 has its own associated RAN 5 (e.g., the Network Relay UE 30001 has or is associated with a RAN 501), the Network Relay UE 30 can connect to the same RAN 5 with other Network Relay UE 30. For example, both the Network Relay UE 30001 and the Network Relay UE 30002 can connect to the RAN 501.

In one example, the Remote UE 310 may connect to a RAN 5 directly over the Uu interface to configure an enhanced Multi Access-PDU (MA PDU) Session while other connections may be established via Network Relay UE 30 and RAN 5.

The Remote UE 310 and the UPF 72 may support an enhanced ATSSS-LL functionality. The ATSSS-LL functionality is defined in 3GPP TS 23.501 (NPL 2) and 3GPP TS 23.502 (NPL 3). In addition to the ATSSS-LL functionality, the enhanced ATSSS-LL functionality may provide at least one of the following functionalities.

The enhanced ATSSS-LL functionality in the Remote UE 310 or the UPF 72 may not apply a specific protocol. It is a data switching function, which decides how to steer, switch and split the uplink traffic among multiple 3GPP/non-3GPP accesses based on the provisioned eATSSS Rule and local conditions (e.g., signal loss conditions). The ATSSS-LL functionality in the Remote UE 310 or the UPF 72 may be applied to steer, switch and split all types of traffic, including TCP traffic, UDP traffic, Ethernet traffic, etc.

The enhanced ATSSS-LL functionality may be enabled in the Remote UE 310 in a case where the Remote UE 310 provides a “Multi path relay capability” during the Registration procedure.

The enhanced ATSSS-LL functionality may be enabled in the Remote UE 310 in a case where the Remote UE 310 provides an “enhanced ATSSS-LL capability” during the PDU Session Establishment procedure.

The Remote UE 310 and the UPF 72 may maintain an enhanced ATSSS Rule for the multi-path indirect network connections. The ATSSS Rule is defined in 3GPP TS 23.501 (NPL 2) and 3GPP TS 23.502 (NPL 3). The enhanced ATSSS Rule is generated by an SMF 71, by contacting to a PCF 73 and is sent to the Remote UE 310 and the UPF 72.

For example, the SMF 71 may contact to the PCF 73 and receive information for generating the enhanced ATSSS Rule from the PCF 73, and the SMF 71 may generate the enhanced ATSSS Rule based on the received information. The SMF 71 may generate the enhanced ATSSS Rule based on local policy or local configuration in the SMF 71. The SMF 71 may send the generated enhanced ATSSS Rule to the Remote UE 310 and the UPF 72.

The enhanced ATSSS Rule for the UPF 72 can be included in N4 rule or independent from the N4 rule. In addition to the ATSSS Rule, the enhanced ATSSS Rule may include at least one of the following information.
Multi-Active-Standby: It is used to steer a service data flow (SDF) on multiple accesses (e.g., the Active accesses), when multiple accesses are available, and to switch the SDF to the available other Active access when Active access becomes unavailable. When the Active access becomes available again, the SDF is switched back to this access.
Smallest Delay: It is used to steer an SDF to the access that is determined to have the smallest Round-Trip Time (RTT). The measurements may be obtained by the Remote UE 310 and the UPF 72 to determine the RTT over multiple 3GPP accesses. In addition, if one access becomes unavailable, all SDF traffic (all the traffic of an SDF or the SDF) is switched to the other available access. It can only be used for the Non-GBR SDF.

Load-Balancing: It is used to split an SDF across multiple 3GPP accesses if multiple 3GPP accesses are available. It contains the percentage of the SDF traffic that is sent over each 3GPP accesses. Load-Balancing may be only applicable to Non-GBR SDF. In addition, if one access becomes unavailable, all SDF traffic (all the traffic of an SDF) is switched to the other available access.

Priority-based: It is used to steer all the traffic of an SDF (or the SDF) to the high priority access, until this access is determined to be congested. In this case, the traffic of the SDF (or the SDF) is sent also to the low priority access, i.e., the SDF traffic (or the SDF) is split over multiple 3GPP accesses. In addition, when the high priority access becomes unavailable, all SDF traffic (or the SDF) is switched to the low priority access. It can only be used for the Non-GBR SDF. For example, the Remote UE 310 may determine that the congestion occurs based on local policy or local configuration in the Remote UE 310. For example, in a case where the Remote UE 310 receives information indicating that the congestion occurs other network node(s), the Remote UE 310 may determine that the congestion occurs. The UPF 72 may determine that the congestion occurs in the same manner as the Remote UE 310.

The enhanced ATSSS Rule may be applied to non-3GPP accesses.

The enhanced Access Traffic Steering, Switching, Splitting (ATSSS) functionality may be called as other ways, for example, ATSSS for multi-path indirect network connections, Multi Path ATSSS (MPATSSS), enhanced ATSSS (eATSSS), enhanced ATSSS (eATSSS) functionality and etc.

A capability of the enhanced ATSSS functionality in the SMF 71 and the UPF 72 can be expressed as an enhanced ATSSS capability. The enhanced ATSSS capability may be called as other ways, for example, eATSSS capability and etc.

The capability of the enhanced ATSSS functionality may indicate that the SMF 71 or the UPF 72 supports the enhanced ATSSS functionality.

The capability of the enhanced ATSSS functionality may indicate that the SMF 71 or the UPF 72 is able to perform appropriate process(es) using the enhanced ATSSS Rule.

The capability of the enhanced ATSSS functionality may indicate that the SMF 71 or the UPF 72 is able to perform at least one of the above-mentioned steering of the SDF and the above-mentioned splitting of the SDF using the enhanced ATSSS Rule.

The capability of the enhanced ATSSS functionality may indicate that the SMF 71 or the UPF 72 is able to perform communication in multi-path indirect network connections.

The capability of the enhanced ATSSS functionality may indicate that the SMF 71 or the UPF 72 is able to perform communication in multi-path indirect network connections using at least one of the enhanced ATSSS Rule and the enhanced ATSSS functionality.

For example, at least one of the Remote UE 310, the SMF 71 and the UPF 72 may handle or perform the eATSSS functionality (e.g., including at least one of the above-mentioned steering of the SDF and the above-mentioned splitting of the SDF etc.) using the enhanced ATSSS Rule.

For example, at least one of the Remote UE 310, the SMF 71 and the UPF 72 may perform at least one of the above-mentioned steering of the SDF and the above-mentioned splitting of the SDF using the enhanced ATSSS Rule.

For example, at least one of the Remote UE 310, the SMF 71 and the UPF 72 may perform at least one of the above-mentioned steering of the SDF and the above-mentioned splitting of the SDF by performing the enhanced ATSSS-LL functionality using the enhanced ATSSS Rule.

For example, at least one of the Remote UE 310, the SMF 71 and the UPF 72 may perform communication in multi-path indirect network connections using the enhanced ATSSS Rule.

The at least one of the Remote UE 310, the SMF 71 and the UPF 72 may store the enhanced ATSSS Rule.

The at least one of the Remote UE 310, the SMF 71 and the UPF 72 may store the enhanced ATSSS Rule in advance. The at least one of the Remote UE 310, the SMF 71 and the UPF 72 may receive the enhanced ATSSS Rule in advance from other network node(s).

For example, at least one of the Remote UE 310, the SMF 71 and the UPF 72 may determine which path is used for the communication based on the enhanced ATSSS Rule.

For example, in a case where there are three multi-path indirect network connections (e.g., a first connection or path via the Network Relay UE 30001, a second connection or path via the Network Relay UE 30002 and a third connection or path via the Network Relay UE 30003), at least one of the Remote UE 310, the SMF 71 and the UPF 72 may determine one of the connections or paths used for the communication based on the enhanced ATSSS Rule.

A policy of the enhanced ATSSS functionality in the PCF 73 can be expressed as an enhanced ATSSS policy. The enhanced ATSSS policy may be called as other ways, for example, eATSSS policy and etc.

The enhanced ATSSS-LL functionality may be called as other ways, for example, eATSSS-LL functionality, ATSSS-LL for multi-path indirect network connections, Multi Path ATSSS-LL (MPATSSS-LL), Enhanced ATSSS-LL (eATSSS-LL) and etc.

The enhanced ATSSS Rule may be called as other ways, for example, ATSSS Rule for multi-path indirect network connections, eATSSS Rule, Multi Path ATSSS Rule (MPATSSS Rule), enhanced STSSS Rule (eATSSS Rule), eATSSS Rule and etc.

The enhanced Multi Access-PDU (MA PDU) Session may be called as other ways, for example, MA PDU Session for multi-path indirect network connections, enhanced MA PDU Session (eMA PDU Session) and etc.

The communication in the multi-path indirect network connections or the communication performed in the multi-path indirect network connections may include communication on or via or over or in or using the eMA PDU Session.

The enhanced Access Traffic Steering, Switching, Splitting (ATSSS) functionality may include the enhanced ATSSS-LL functionality.

The enhanced ATSSS-LL functionality may include the enhanced Access Traffic Steering, Switching, Splitting (ATSSS) functionality.

The enhanced ATSSS Rule may be used for at least one of the enhanced Access Traffic Steering, Switching, Splitting (ATSSS) functionality and the enhanced ATSSS-LL functionality.

The enhanced ATSSS Rule may be a rule used for at least one of the enhanced Access Traffic Steering, Switching, Splitting (ATSSS) functionality and the enhanced ATSSS-LL functionality.

### (Second Example of the First Aspect)

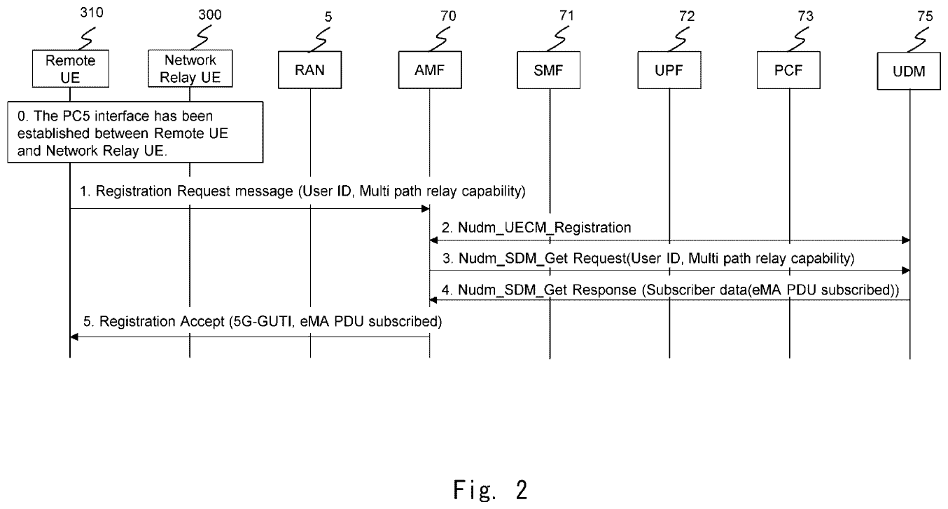

FIG. 2 includes an example of the Registration procedure for the Remote UE 310. The detailed processes of the Second example of the First Aspect are described below with reference to FIG. 2.

Step 0. A communication path between the Remote UE 310 and the Network Relay UE 300 over PC5 interface has been established in accordance with 3GPP TS 23.304 (NPL 7).

Step 1. The Remote UE 310 sends a Registration Request message to an AMF 70 including at least one of User ID, Requested NSSAI, and Multi path relay capability. The Remote UE 310 may send the Registration Request message to the AMF 70 via the Network Relay UE 300. For example, the Network Relay UE 300 may be the Network Relay UE 30001, the Network Relay UE 30002 or the Network Relay UE 30003 as illustrated in FIG. 1.

The following bullets explain each parameter in detail.
User ID (e.g., the User ID may be expressed as User Identity) may be a 5G-GUTI, SUCI or SUPI. For example, the User Identity may be a 5G-GUTI, SUCI or SUPI for the Remote UE 310.

Multi path relay capability indicates that the Remote UE 310 supports handling of the multi-path indirect network connections as disclosed by this disclosure. In one example, the Multi path relay capability may indicate that the Remote UE 310 supports handling of or performing the enhanced Access Traffic Steering, Switching, Splitting (ATSSS) functionality or process(es) as disclosed by the First Aspect in this disclosure. The Multi path relay capability may be defined in the 5GMM capability. The Multi path relay capability may indicate that the Remote UE 310 supports multi-path indirect network connections. The Multi path relay capability may indicate that the Remote UE 310 supports connection via the Network Relay UE 30001, connection via the Network Relay UE 30002 and connection via the Network Relay UE 30003 as illustrated in FIG. 1.

Step 2. Upon reception of the Registration Request message in step 1, the AMF 70 invokes an Nudm_UECM_Registration service to a UDM 75 in a HPLMN to register AMF 70 as the current AMF node for the Remote UE 310.

Step 3. After the completion of the Nudm_UECM_Registration service in step 2, the AMF 70 sends an Nudm_SDM_Get Request message to the UDM 75 in the HPLMN including the User ID and the Multi path relay capability. See step 1 for detail of the User ID and the Multi path relay capability.

Step 4. The UDM 75 finds Subscriber data for the Remote UE 310 and sends an Nudm_SDM_Get Response message to the AMF 70 including the Subscriber data for the Remote UE 310. The Subscriber data includes eMA PDU subscribed. The UDM 75 may provide the eMA PDU subscribed to the AMF 70 as a part of the 5G ProSe subscription data. The UDM 75 may provide the eMA PDU subscribed to the AMF 70 only if the UDM 75 receives the Multi path relay capability from the AMF 70 in step 3.

The eMA PDU subscribed indicates that the Remote UE 310 is allowed to establish eMA PDU Session as subscriber data. The eMA PDU subscribed indicates that the Remote UE 310 is allowed to establish the eMA PDU Session.

The eMA PDU subscribed may exist per S-NSSAI in the Subscribed NSSAI. The eMA PDU subscribed may indicate that the Remote UE 310 is allowed to communicate on or via or over or using the eMA PDU Session. The eMA PDU subscribed may indicate that the Remote UE 310 is allowed to communicate using multi-path indirect network connections.

The eMA PDU subscribed may also indicate the maximum number of PC5 connections that the Remote UE 310 can establish with one eMA PDU Session. The maximum number of PC5 connections is referred by the AMF 70 in a case where the AMF 70 receives a request from the Remote UE 310 to add more PDU

Session to the established eMA PDU Session. If the request is an attempt to equal or exceed the maximum number of PC5 connections, the AMF 70 rejects this request and sends an MM reject message to the Remote UE 310.

For example, if the request is an attempt to equal or exceed the maximum number of PC5 connections, the AMF 70 rejects this request and sends an MM reject message to the Remote UE 310 with the cause. The cause may indicate that the request is an attempt to equal or exceed the maximum number of PC5 connections. The cause may indicate that the request is rejected because the request is an attempt to equal or exceed the maximum number of PC5 connections.

For example, in a case where the AMF 70 determines that it reaches the maximum number of PC5 connections for the Remote UE 310 by the request, the AMF 70 may reject this request and send the MM reject message to the Remote UE 310.

For example, in a case where the AMF 70 determines that the current number of PC5 connections for the Remote UE 310 will be equal to or will exceed the maximum number of PC5 connections if the PC5 connection is established by the request, the AMF 70 may reject this request and send the MM reject message to the Remote UE 310.

Step 5. After the AMF 70 obtains the Subscriber data for the Remote UE 310 from the UDM 75 in step 4, the AMF 70 sends a Registration Accept message to the Remote UE 310 including 5G-GUTI and the eMA PDU subscribed.

If the Remote UE 310 receives the eMA PDU subscribed from the AMF 70 in the Registration Accept message, the Remote UE 310 recognizes that the Remote UE 310 is able to establish the multi-path indirect network connections or the eMA PDU Session. If the eMA PDU subscribed indicates the maximum number of PC5 connections that the Remote UE 310 can establish for one eMA PDU Session, the maximum PC5 connection is stored by the Remote UE 310 and referred by the Remote UE 310 when the Remote UE 310 adds more PDU Session to the established eMA PDU Session. The Remote UE 310 may request to add more PDU Session to the established eMA PDU Session up to the received maximum number of PC5 connections. In one example, the eMA PDU subscribed may be expressed by another way, for example, eMA PDU supported, multiple PDU supported and etc.

(Variant 1 of Second example of the First Aspect)

In step 5, if the AMF 70 does not support the multi-path indirect network connections or the MA PDU Session, the AMF 70 does not include the eMA PDU subscribed in the Registration Accept message in step 5. I.e., If the AMF 70 does not support the multi-path indirect network connections or the MA PDU Session, the AMF 70 cannot digest the Multi path relay capability parameter in step 1 as it is added in this disclosure. However, the AMF 70 can perform the Registration Procedure without support of the multi-path indirect network connections or the MA PDU Session.

In a case where the Remote UE 310 receives the Registration Accept message without the eMA PDU subscribed although the Remote UE 310 sends the Multi path relay capability to the AMF 70 in Registration Request message in step 1, the Remote UE 310 recognizes that the Remote UE 310 is not able to establish the multi-path indirect network connections or the eMA PDU Session due to lack of support by the AMF 70 or the Remote UE 310 does not have subscription to the multi-path indirect network connections. For example, if the AMF 70 does not support the multi-path indirect network connections or the MA PDU Session and the AMF 70 receives the Registration Request message in step 1, the AMF 70 may send a message indicating that the AMF 70 does not support the multi-path indirect network connections or the MA PDU Session or the AMF 70 may send a Registration Reject message to reject the Registration Request message.

### Third Example of the First Aspect

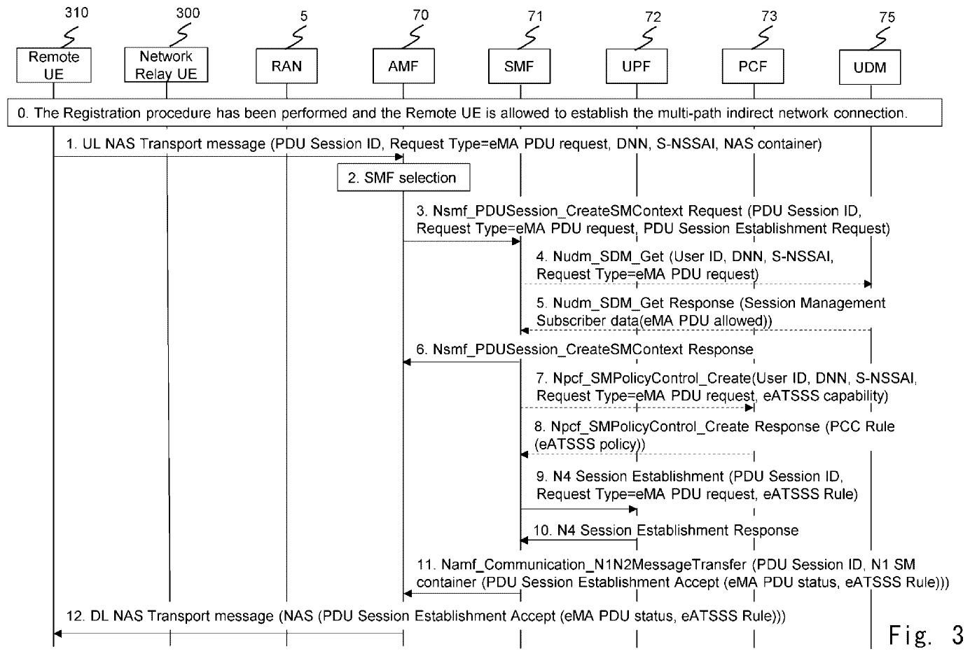

FIG. 3 includes an example of the PDU Session establishment procedure for the multi-path indirect network connections with enhanced ATSSS functionality.

In order to configure the eMA PDU Session using multiple Network Relay UEs 300, the Remote UE 310 needs to repeat a PDU Session establishment procedure in FIG. 3 multiple times as many as the Remote UE 310 duplicates the PC5 connections for the eMA PDU Session.

As the eATSSS Rule is configured to both the Remote UE 310 and the UPF 72 by this procedure, User data between the Remote UE 310 and an AF 201 in a data network 20 is handled according to the eATSSS Rule in both the Remote UE 310 and the UPF 72 and results reliable user data transmission over the PC5 interface. The procedure to establish the multi-path indirect network connections is illustrated in the Fourth example of the First Aspect.

The detailed processes of the Third example of the First Aspect are described below with reference to FIG. 3.

Step 0. A communication path between the Remote UE 310 and the Network Relay UE 300 over PC5 interface has been established in accordance with 3GPP TS 23.304 (NPL 7). The Registration procedure has been performed by the Network Relay UE 300 successfully and the Remote UE 310 is allowed to establish the multi-path indirect network connections. For example, in step 0, the Remote UE 310 may be registered by performing the process(es) in FIG. 2. For example, the Network Relay UE 300 may be the Network Relay UE 30001, the Network Relay UE 30002 or the Network Relay UE 30003 as illustrated in FIG. 1.

Step 1. The Remote UE 310 sends a UL NAS Transport message to the AMF 70 including at least one of PDU Session ID, Request Type which is set to eMA PDU request, DNN, S-NSSAI and NAS container. The NAS container may include a PDU Session Establishment Request message, a Service Request message or any other NAS message with the purpose of establishing an eMA PDU Session or with the purpose to re-use an already established eMA PDU Session or modify the already established eMA PDU Session. For example, in a case where the Remote UE 310 receives the eMA PDU subscribed, the Remote UE 310 may send the UL NAS Transport message.

The following bullets explain each parameter in detail.
PDU Session ID is the Association between the Remote UE 310 and the Data Network 20 that provides a PDU connectivity service. For example, the PDU Session ID may be an identifier or identity (ID) indicating or identifying an association between the Remote UE 310 and the Data Network 20 that provides a PDU connectivity service.

Request Type which is set to eMA PDU request indicates that the Remote UE 310 requests to establish the eMA PDU session. Request Type which is set to eMA PDU may be expressed as “Request Type=eMA request”. Request Type which is set to eMA PDU request may indicate that the Remote UE 310 requests to communicate on or via or over or using the eMA PDU session. Request Type which is set to eMA PDU request may indicate that the Remote UE 310 requests to communicate using the multi-path indirect network connections. Request Type which is set to eMA PDU request may indicate that the Remote UE 310 requests to establish the multi-path indirect network connections. For example, the Remote UE 310 may set the Request Type to eMA PDU request only when the Remote UE 310 has the eATSSS capability.
DNN is a Data Network Name that is equivalent to an APN in EPS. The DNN is a reference to a data network.
S-NSSAI is a Single NSSAI that indicates a network slice.

In one example, the PDU Session Establishment Request message, Service Request message or any other NAS message embedded in the UL NAS Transport message may include the Request Type which is set to eMA PDU request.

The Remote UE 310 may send the UL NAS Transport message during the PDU Session Establishment procedure.

Step 2. Upon reception of the UL NAS Transport message from the Remote UE 310, the AMF 70 performs the SMF selection. For example, the AMF 70 may perform the SMF selection based on at least one of the received Request Type which is set to eMA PDU request, S-NSSAI, DNN from the Remote UE 310. The AMF 70 selects an SMF 71 that supports the eATSSS functionality and, in addition, the selected SMF 71 has to have an associated UPF 72 that supports the eATSSS functionality as well. An SMF 71 to be chosen and associated UPF 72 with the SMF 71 have to have an eATSSS capability.

For example, the AMF 70 may store information indicating SMF and UPF associated with the SMF which have the eATSSS capability. For example, based on the stored information, the AMF 70 may select the SMF 71 and the UPF 72 which have the eATSSS capability. For example, in a case where the AMF 70 receives the Request Type which is set to eMA PDU request, the AMF 70 may select, based on the stored information, the SMF 71 and the UPF 72 which have the eATSSS capability. For example, the AMF 70 may receive the information indicating SMF and UPF associated with the SMF which have the eATSSS capability from other network node(s). For example, the AMF 70 may know which SMF and UPF have the eATSSS capability in advance.

For example, the Remote UE 310 may provide the enhanced ATSSS-LL capability to the AMF 70 by the UL NAS Transport message in step 1. The enhanced ATSSS-LL capability may indicate that the Remote UE 310 supports handling of the multi-path indirect network connections as disclosed by this disclosure. The enhanced ATSSS-LL capability may indicate that the Remote UE 310 supports handling of or performing the enhanced Access Traffic Steering, Switching, Splitting (ATSSS) functionality or handling of or performing the enhanced ATSSS-LL functionality.

In a case where the AMF 70 receives the enhanced ATSSS-LL capability, the AMF 70 may perform the SMF selection in step 2.

Step 3. Once the SMF 71 is chosen, the AMF 70 sends an Nsmf_PDUSession_CreateSMContext Request message to the SMF 71 including at least one of the PDU Session ID, the Request Type which is set to eMA PDU request, and NAS message containing the PDU Session Establishment Request message.

The NAS message may include the Service Request message or the any other NAS message mentioned in step 1 instead of or in addition to the PDU Session Establishment Request message.

The Nsmf_PDUSession_CreateSMContext Request message may include at least one of User ID (The User ID may be set with SUPI for the Remote UE 310), the DNN and the S-NSSAI.

PDU Session ID, DNN, S-NSSAI, Request Type which is set to eMA PDU request and PDU Session Establishment Request message in step 3 may be same ones in step 1.

Step 4. In a case where the SMF 71 does not hold Session Management Subscriber data, the SMF 71 may send an Nudm_SDM_Get message to the UDM 75 including at least one of User ID, DNN, S-NSSAI, and Request Type which is set to eMA PDU request. The User ID may be set with SUPI. The User ID may be set with SUPI for the Remote UE 310. See step 1 for detail of DNN, S-NSSAI, Request Type which is set to eMA PDU request. DNN, S-NSSAI, Request Type which is set to eMA PDU request in step 4 may be same ones in step 1.

Step 5. Upon reception of the Nudm_SDM_Get message from the SMF 71, the UDM 75 may send an Nudm_SDM_Get Response message to the SMF 71 including the Session Management Subscriber data. The Session Management Subscriber data may include eMA PDU allowed. The eMA PDU allowed indicates that the Remote UE 310 is allowed to establish eMA PDU Session to at least one of the DNN and S-NSSAI as indicated in the Nudm_SDM_Get message in step 4.

The eMA PDU allowed may indicate that the Remote UE 310 is allowed to establish eMA PDU Session. The eMA PDU allowed may indicate that the Remote UE 310 is allowed to establish communication on or via or over or using the eMA PDU Session. The eMA PDU allowed may indicate that the Remote UE 310 is allowed to establish communication using multi-path indirect network connections.

The eMA PDU allowed may also indicate that the maximum number of PC5 connections that the Remote UE 310 can establish to at least one of the DNN and the S-NSSAI. The maximum number of PC5 connections is referred by the SMF 71 in a case where the SMF 71 receives a request from the Remote UE 310 to add more PDU Session to the established eMA PDU Session. If the request is an attempt to equal or exceed the maximum number of PC5 connections, the SMF 71 rejects this request and sends an SM reject message to the Remote UE 310. For example, if the request is an attempt to equal or exceed the maximum number of PC5 connections, the SMF 71 rejects this request and sends an SM reject message to the Remote UE 310 with the cause. The cause may indicate that the request is an attempt to equal or exceed the maximum number of PC5 connections. The cause may indicate that the request is rejected because the request is an attempt to equal or exceed the maximum number of PC5 connections.

For example, in a case where the SMF 71 determines that it will reach the maximum number of PC5 connections for the Remote UE 310 by the request, the SMF 71 may reject this request and send the SM reject message to the Remote UE 310.

For example, in a case where the SMF 71 determines that the current number of PC5 connections for the Remote UE 310 will be equal to or will exceed the maximum number of PC5 connections if the PC5 connection is established by the request, the SMF 71 may reject this request and send the SM reject message to the Remote UE 310.

Step 6. The SMF 71 sends an Nsmf_PDUSession_CreateSMContext Response message to the AMF 70.

For example, in a case where the SMF 71 receives the Nsmf_PDUSession_CreateSMContext Request message and has already the Session Management Subscriber data, the SMF 71 may not send the Nudm_SDM_Get message. In this case the SMF 71 may send the Nsmf_PDUSession_CreateSMContext Response after receiving the Nsmf_PDUSession_CreateSMContext Request message.

For example, in a case where the SMF 71 receives the Nudm_SDM_Get Response message, the SMF 71 sends the Nsmf_PDUSession_CreateSMContext Response.

Step 7. In a case where the SMF 71 does not have PCF association, the SMF 71 may send an Npcf_SMPolicyControl_Create message to the PCF 73 including at least one of User ID, DNN, S-NSSAI, Request Type which is set to eMA PDU request and eATSSS capability. The User ID may be set with SUPI. The User ID may be set with SUPI for the Remote UE 310. The eATSSS capability indicates a capability of at least one of the SMF 71 and associated UPF 72 for handling of eATSSS functionality.

For example, the eATSSS capability may indicate that at least one of the SMF71 and the UPF 72 supports the enhanced ATSSS functionality.

For example, the eATSSS capability may indicate that at least one of the SMF71 and the UPF 72 supports the enhanced ATSSS-LL functionality.

For example, the eATSSS capability may indicate that at least one of the SMF71 and the UPF 72 supports multi-path indirect network connections.

See step 1 for detail of DNN, S-NSSAI, Request Type which is set to eMA PDU request.

DNN, S-NSSAI, Request Type which is set to eMA PDU request in step 7 may be same ones in step 1.

User ID, DNN, S-NSSAI, Request Type which is set to eMA PDU request in step 7 may be same ones sent in step 4.

For example, in a case where the SMF 71 has PCF association or has eATSSS policy (e.g., eATSSS policy for the Remote UE 310), the SMF 71 may not perform step 7.

Step 8. Upon reception of the Npcf_SMPolicyControl_Create message from the SMF 71, the PCF 73 may examine the request and provide the eATSSS policy. The eATSSS policy may be included in PCC Rule. The PCF 73 may make the eATSSS policy. The eATSSS policy is made based on the eATSSS capability and Subscription data. The Subscription data may be for the Remote UE 310. The PCF 73 may make the eATSSS policy based on local policy or local configuration in the PCF 73. Note that the PCF 73 may have downloaded the Subscription data for the Remote UE 310 from the UDM 75 in advance. The eATSSS policy may be a policy for at least one of the eATSSS, the eATSSS functionality and the eATSSS-LL functionality.

The eATSSS policy may include the eMA PDU allowed. The PCC Rule may include the eMA PDU allowed. See step 5 for detail of the eMA PDU allowed.

For example, in a case where the Subscription data includes information indicating the Remote UE 310 is allowed to establish eMA PDU Session to at least one of the DNN and S-NSSAI as indicated in the Npcf_SMPolicyControl_Create message in step 7 and the PCF 73 receives the eATSSS capability, the PCF 73 may make or generate the eATSSS policy including the eMA PDU allowed.

For example, in a case where the Subscription data includes information indicating the Remote UE 310 is allowed to establish eMA PDU Session and the PCF 73 receives the eATSSS capability, the PCF 73 may make or generate the eATSSS policy including the eMA PDU allowed.

For example, in a case where the Subscription data includes the Multi path relay capability regarding the Remote UE 310 and the PCF 73 receives the eATSSS capability, the PCF 73 may make or generate the eATSSS policy including the eMA PDU allowed.

For example, the eATSSS policy may include information for generating the eATSSS Rule.

For example, the eATSSS policy may include information for determining the percentage of the SDF traffic that is sent over each 3GPP accesses. This information may be used for determining “Load-Balancing” Rule in the eATSSS Rule.

For example, the eATSSS policy may include information for determining the priority for each 3GPP accesses. This information may be used for “Priority-based” Rule in the eATSSS Rule.

The SMF 71 generates the eATSSS Rule and N4 rule for the UPF 72 based on the received eATSSS policy from the PCF 73. The eATSSS Rule may be included in the N4 rule. Alternatively, the N4 rule may be included in the eATSSS Rule.

For example, the SMF 71 may generate the eATSSS Rule based on local policy or local configuration in the SMF 71.

For example, the SMF 71 may generate the eATSSS Rule based on at least one of the received eATSSS policy and local policy and local configuration in the SMF 71.

For example, the SMF 71 may generate the eATSSS Rule based on the above-mentioned information in the eATSSS policy. The above-mentioned information in the eATSSS policy may be stored in the SMF 71 in advance.

For example, the eATSSS Rule may include the eATSSS policy. For example, the SMF 71 may generate the eATSSS Rule by including the eATSSS policy to the eATSSS Rule.

Step 9. The SMF 71 sends an N4 Session Establishment message to the UPF 72 including at least one of the PDU Session ID, the Request Type which is set to eMA PDU request and the eATSSS Rule in order to reserve user plane resources for the eMA PDU Session and install the eATSSS Rule.

Step 10. After successful resource reservation for the eMA PDU Session and successful installation of the eATSSS Rule, the UPF 72 sends an N4 Session Establishment Response message to the SMF 71.

Step 11. The SMF 71 sends an Namf_Communication_NIN2Message Transfer message to the AMF 70 including N1 SM container. The N1 SM container contains a PDU Session Establishment Accept message, a Service Accept message or any other NAS message. The PDU Session Establishment Accept message or other SM message (e.g., Service Accept message or any other NAS message) includes eMA PDU status and the eATSSS Rule. The eMA PDU status indicates that a status of the eMA PDU session indicating whether 5GS (e.g., network) accepts the request to establish the eMA PDU Session.

The eMA PDU status may indicate whether 5GS accepts the request to establish the eMA PDU Session.

The eMA PDU status may indicate that 5GS accepts the request to establish the eMA PDU Session.

For example, the SMF 71 may configure the eMA PDU status indicating whether 5GS accepts the request to establish the eMA PDU Session based on local policy or local configuration in the SMF 71.

For example, the SMF 71 may configure the eMA PDU status indicating that 5GS accepts the request to establish the eMA PDU Session in a case where steps 4 to 10 are completed successfully.

For example, the SMF 71 may configure the eMA PDU status indicating that 5GS accepts the request to establish the eMA PDU Session in a case where the current number of PC5 connections for the Remote UE 310 will not be equal to or will not exceed the maximum number of PC5 connections (the maximum number may be one mentioned in step 5) if the PC5 connection is established by the request.

The eMA PDU status may also indicate that the maximum number of PC5 connections that the Remote UE 310 can establish to at least one of the DNN and S-NSSAI. The maximum number of PC5 connections is stored and referred by the Remote UE 310 in a case where the Remote UE 310 adds more PDU Session to the established eMA PDU Session. The Remote UE 310 may request to add more PDU Session to the established eMA PDU Session up to the received maximum number of PC5 connections. The SMF 71 may send the eMA PDU status to the UPF 72. The SMF 71 may generate and send the eMA PDU status to the UPF 72 in step 9.

The eMA PDU status may indicate that 5GS does not accept the request to establish the eMA PDU Session. The eMA PDU status indicating that 5GS does not accept the request to establish the eMA PDU Session may be included in the SM reject message sent to the Remote UE 310 mentioned in step 5. The eMA PDU status indicating that 5GS does not accept the request to establish the eMA PDU Session may be included in a reject message (e.g., a PDU Session Establishment Reject message) sent to the Remote UE 310. For example, the PDU Session Establishment Reject message may be included in the N1 SM container.

For example, the SMF 71 may configure the eMA PDU status indicating that 5GS does not accept the request to establish the eMA PDU Session in a case where steps 4 to 10 are not completed successfully.

For example, the SMF 71 may configure the eMA PDU status indicating that 5GS does not accept the request to establish the eMA PDU Session in a case where the current number of PC5 connections for the Remote UE 310 will be equal to or will exceed the maximum number of PC5 connections (the maximum number may be one mentioned in step 5) if the PC5 connection is established by the request.

Step 12. The AMF 70 sends a DL NAS Transport message to the Remote UE 310 including the PDU Session Establishment Accept message, the Service Accept message or any other NAS message. The PDU Session Establishment Accept message or other SM message (e.g., Service Accept message or any other NAS message) includes the eMA PDU status and the eATSSS Rule. See step 11 for detail of the eMA PDU status and the eATSSS Rule.

The order of steps 4 and 7 may be reversed.

### Variant 1 of Third Example of the First Aspect

If the Remote UE 310 sends the PDU Session Establishment Request message in step 1 for adding more PC5 connection to existing eMA PDU Session and receives the SM reject message or the PDU Session Establishment Reject message, the Remote UE 310 does not add new PC5 connection due to rejection but the Remote UE 310 maintains already established PC5 connections for the eMA PDU Session. This rejection does not affect to the existing PC5 connections for the eMA PDU Session.

### Fourth Example of the First Aspect

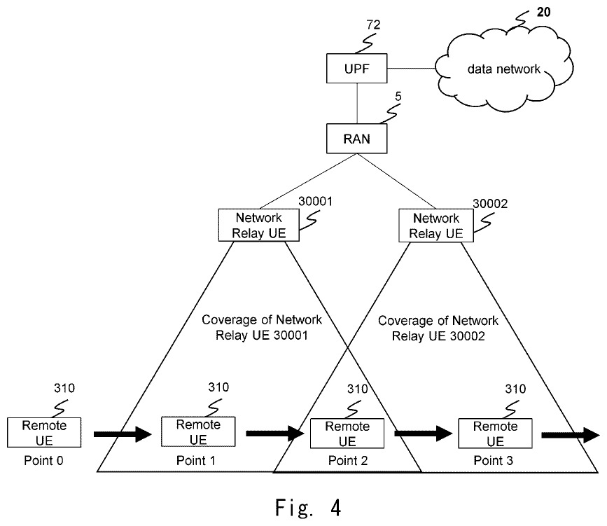

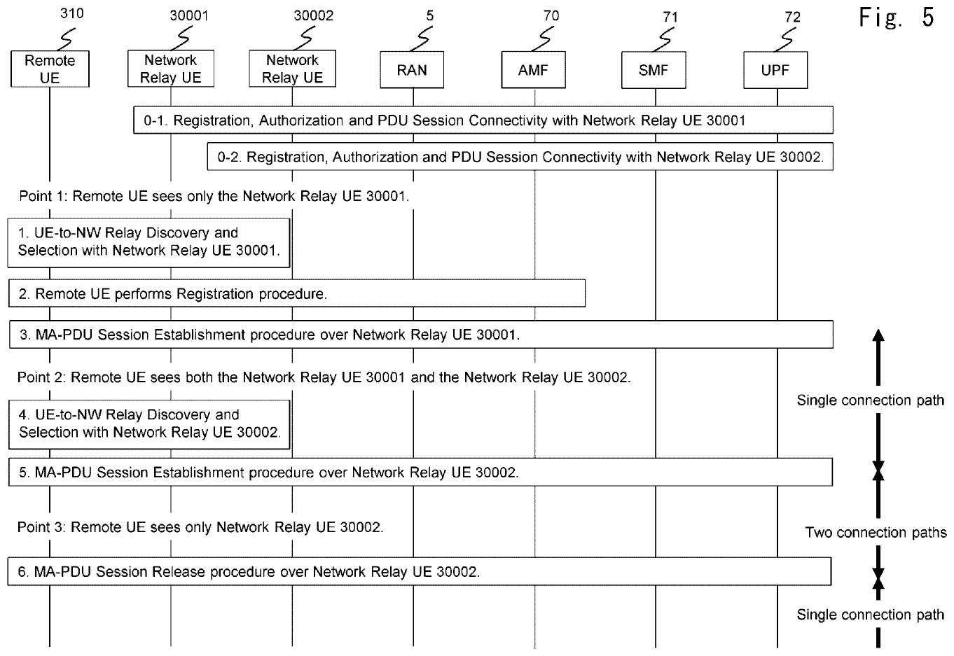

Fourth example of the First Aspect includes how the multi-path indirect network connections can be established and updated based on a move of the Remote UE 310 using FIG. 4 and FIG. 5.

FIG. 4 shows a Remote UE movement as an example. In FIG. 4, the Remote UE 310 moves from the left-hand side to the right-hand side.

At the Point 0: The Remote UE 310 is in RM-DEREGISTERED state. For example, the Remote UE 310 switches on at the Point 0 after successful Deregistration procedure.

At the Point 1: Due to a move, the Remote UE 310 can see a signal from the Network Relay UE 30001 as Remote UE 310 is under the coverage of the Network Relay UE 30001.

At the Point 2: The Remote UE 310 can see signals both from the Network Relay UE 30001 and the Network Relay UE 30002 as Remote UE 310 is under the coverages of both the Network Relay UE 30001 and the Network Relay UE 30002.

At the point 3: The Remote UE 310 can see a signal only from the Network Relay UE 30002 as the Remote UE 310 is outside the coverage of the Network Relay UE 30001 and is in the coverage of the Network Relay UE 30002.

Taking this Remote UE 310 movement as an example, FIG. 5 explains how the multi-path indirect network connections are configured and returns back to a single path indirect network connection.

FIG. 5 shows an example of multi-path indirect network connections using enhanced ATSSS functionality. The detailed procedure of the Fourth example of the First Aspect is described below with reference to both FIG. 4 and FIG. 5.

The following steps explains the steps in FIG. 5.

Step 0-1. The Network Relay UE 30001 performs the Registration procedure with the AMF 70 and at least one PDU Session is established with the SMF 71 and UPF 72.

Step 0-2. The Network Relay UE 30002 performs the Registration procedure with the AMF 70 and at least one PDU Session is established with the SMF 71 and UPF 72. In one example, the SMF 71 and UPF 72 may be same or different from ones for the Network Relay UE 30001.

* Point 1: The Remote UE sees only the Network Relay UE 30001:

Step 1. As the Remote UE 310 sees the signal from the Network Relay UE 30001, the Remote UE 310 performs the UE-to-NW Relay Discovery and Selection with the Network Relay UE 30001 in accordance with 3GPP TS 23.304 (NPL 7).

Step 2. After successful UE-to-NW Relay Discovery and Selection with the Network Relay UE 30001 in step 1, the Remote UE 310 initiates the Registration procedure as disclosed by the Second example of the First Aspect.

Step 3. After successful Registration procedure, the Remote UE 310 initiates the MA PDU Session Establishment procedure over or for or to the Network Relay UE 30001 as disclosed by the Third example of the First Aspect. The procedure included in the Third example of the First Aspect may be expressed as a MA PDU Session Establishment procedure or an eMA PDU Session Establishment procedure a PDU Session Establishment procedure for the MA PDU Session, a PDU Session Establishment procedure for the eMA PDU Session etc.

After successful MA PDU Session Establishment procedure, the Remote UE 310 communicates with the AF 201 in the data network 20 with single connection path between the Remote UE 310 and the UPF 72.

At this point, at least one of the Remote UE 310, AMF 70, SMF 71 and UPF 72 stores the eMA PDU status and eATSSS Rule for managing the multi-path indirect network connections.

At this point, the eATSSS-LL functionality is installed in both the Remote UE 310 and UPF 72.

For example, the Remote UE 310 may consider that the eATSSS-LL functionality is installed in a case where the Remote UE 310 receives at least one of the eMA PDU status and the eATSSS Rule. For example, the UPF 72 may consider that the eATSSS-LL functionality is installed in a case where the UPF 72 receives at least one of the eMA PDU status and the eATSSS Rule.

For example, the Remote UE 310 may communicate via the Network Relay UE 30001 based on the eATSSS Rule received in step 3.

For example, the Remote UE 310 may perform the eATSSS functionality or the eATSSS-LL functionality based on based on the eATSSS Rule received in step 3. * Point 2: The Remote UE sees both the Network Relay UE 30001 and the Network Relay UE 30002:

Step 4. As the Remote UE 310 sees the signal from the Network Relay UE 30002, the Remote UE 310 performs the UE-to-NW Relay Discovery and Selection with the Network Relay UE 30002 in accordance with 3GPP TS 23.304 (NPL 7). For example, the Remote UE 310 may perform the UE-to-NW Relay Discovery and Selection with the Network Relay UE 30002 while keeping the PDU session established in step 3.

Step 5. After successful UE-to-NW Relay Discovery and Selection with the Network Relay UE 30002 in step 4, the Remote UE 310 initiates the MA PDU Session Establishment procedure over or for or to the Network Relay UE 30002 as disclosed by the Third example of the First Aspect.

For example, the Remote UE 310 may initiate the MA PDU Session Establishment procedure over the Network Relay UE 30002 while keeping the PDU session established in step 3.

For example, in a case where the Remote UE 310 initiates the MA PDU Session Establishment procedure in step 5, the Remote UE 310 may use same PDU Session ID to one used in step 3.

After successful MA PDU Session Establishment procedure, the Remote UE 310 communicates with the AF 201 in the data network 20 with two connection paths between the Remote UE 310 and the UPF 72.

At this point, at least one of the Remote UE 310, AMF 70, SMF 71 and UPF 72 updates eMA PDU status and eATSSS Rule for managing the multi-path indirect network connections.

For example, at least one of the Remote UE 310, AMF 70, SMF 71 and UPF 72 may store at least one of eMA status and eATSSS Rule generated or received in step 5.

For example, at least one of the Remote UE 310, AMF 70, SMF 71 and UPF 72 may store at least one of eMA status and eATSSS Rule generated or received in step 5 independently from the ones stored in step 3.

As two connection paths between the Remote UE 310 and the UPF 72 are established at this point, high resiliency for data connectivity can be achieved.

For example, at this point, the Remote UE 310 may communicate via the Network Relay UE 30001 and via the Network Relay UE 30002.

For example, at this point, the Remote UE 310 may communicate via the Network Relay UE 30001 and via the Network Relay UE 30002 simultaneously.

For example, the Remote UE 310 may communicate via the Network Relay UE 30001 based on at least one of the eATSSS Rule received in step 3 and the eATSSS Rule received in step 5.

For example, the Remote UE 310 may communicate via the Network Relay UE 30002 based on at least one of the eATSSS Rule received in step 3 and the eATSSS Rule received in step 5.

For example, the Remote UE 310 may perform the eATSSS functionality or the eATSSS-LL functionality based on based on at least one of the eATSSS Rule received in step 3 and the eATSSS Rule received in step 5.

In one example, if the Remote UE 310 sees the signal from the RAN 5, the Remote UE 310 may initiate the MA PDU Session Establishment procedure (e.g., the PDU Session Establishment procedure for the MA PDU Session or the PDU Session Establishment procedure for the eMA PDU Session) using Uu interface to the RAN 5. In this case, the UE-to-NW Relay Discovery and Selection in step 4 is not taken place.

* Point 3: The Remote UE sees only Network Relay UE 30002:

Step 6. As the Remote UE 310 cannot maintain the communication path with the Network Relay UE 30001 over the PC5 interface for example due to weak signal strength because of distance between the Remote UE 310 and the Network Relay UE 30001, the Network Relay UE 30001 may initiate the PDU Session Release procedure as described in Section 4.3.4.2 3GPP TS 23.502 (NPL 4), e.g., triggered by the Radio Link Failure (RLF) in lower layer.

After successful PDU Session Release procedure, the Remote UE 310 communicates with the AF 201 in the data network 20 with single connection path between the Remote UE 310 and the UPF 72.

For example, the Remote UE 310 may communicate via the Network Relay UE 30002 based on the eATSSS Rule received in step 5.

For example, the Remote UE 310 may perform the eATSSS functionality or the eATSSS-LL functionality based on the eATSSS Rule received in step 5.

At this point, at least one of the Remote UE 310, AMF 70, SMF 71 and UPF 72 updates eMA PDU status and eATSSS Rule for managing the multi-path indirect network connections.

For example, during the PDU Session Release procedure or after the PDU Session Release procedure, at least one of the Remote UE 310, AMF 70, SMF 71 and UPF 72 may delete the eMA PDU status and the eATSSS Rule which are stored in step 3 or may replace the eMA PDU status and the eATSSS Rule which are stored in step 3 with the eMA PDU status and the eATSSS Rule which are generated or received in step 5.

For example, in case where the Remote UE 310 locates at Point 2 from the beginning (e.g., in a case where the Remote UE 310 switches on at Point 2), the Remote UE 310 may perform steps 1 to 5. In this case, the Remote UE 310 may perform steps 1 to 3 first then perform steps 4 and 5, or the Remote UE 310 may perform steps 4, 2 and 5 first then perform steps 1 and 3.

For example, the Remote UE 310 may perform the enhanced Access Traffic Steering, Switching, Splitting (ATSSS) functionality or the enhanced ATSSS-LL functionality based on the received eATSSS Rule.

For example, at Point 1 or 2, the Remote UE 310 may perform communication via the Network Relay UE 30001 (e.g., the communication includes sending uplink data) based on the received eATSSS Rule. In a case where 3GPP and non-3GPP accesses are available for the communication via the Network Relay UE 30001, the Remote UE 310 may perform the communication via the Network Relay UE 30001 on the 3GPP access or the non-3GPP access. The Remote UE 310 may determine which access is used for the communication based on the eATSSS Rule.

For example, at Point 2 or 3, the Remote UE 310 may perform communication via the Network Relay UE 30002 (e.g., the communication includes sending uplink data) based on the received eATSSS Rule. In a case where 3GPP and non-3GPP accesses are available for the communication via the Network Relay UE 30002, the Remote UE 310 may perform the communication via the Network Relay UE 30002 on the 3GPP access or the non-3GPP access. The Remote UE 310 may determine which access is used for the communication based on the eATSSS Rule.

For example, the UPF 72 may perform the enhanced Access Traffic Steering, Switching, Splitting (ATSSS) functionality or the enhanced ATSSS-LL functionality based on the received eATSSS Rule.

For example, at Point 1 or 2, the UPF 72 may perform communication via the Network Relay UE 30001 (e.g., the communication includes sending downlink data) based on the received eATSSS Rule. In a case where 3GPP and non-3GPP accesses are available for the communication via the Network Relay UE 30001, the UPF 72 may perform the communication via the Network Relay UE 30001 on the 3GPP access or the non-3GPP access. The UPF 72 may determine which access is used for the communication based on the eATSSS Rule.

For example, at Point 2 or 3, the UPF 72 may perform communication via the Network Relay UE 30002 (e.g., the communication includes sending downlink data) based on the received eATSSS Rule. In a case where 3GPP and non-3GPP accesses are available for the communication via the Network Relay UE 30002, the UPF 72 may perform the communication via the Network Relay UE 30002 on the 3GPP access or the non-3GPP access. The UPF 72 may determine which access is used for the communication based on the eATSSS Rule.

The performing the enhanced Access Traffic Steering, Switching, Splitting (ATSSS) functionality or the enhanced ATSSS-LL functionality based on the received eATSSS Rule may include the above-mentioned communication by the Remote UE 310 or by the UPF 72.

The eATSSS Rule may be used for performing the enhanced Access Traffic Steering, Switching, Splitting (ATSSS) functionality or the enhanced ATSSS-LL functionality.

The eATSSS Rule may be information for performing the enhanced Access Traffic Steering, Switching, Splitting (ATSSS) functionality or the enhanced ATSSS-LL functionality.

The eATSSS Rule may include information for controlling the above-mentioned communication by the Remote UE 310 or by the UPF 72.

The eATSSS Rule may be expressed as information for controlling or performing the above-mentioned communication by the Remote UE 310 or by the UPF 72.

The eATSSS Rule may be expressed as information for controlling or performing communication in multi-path indirect network connections.

For example, multi-path indirect network connections may include the connection via or over the Network Relay UE 30001 and the connection via or over the Network Relay UE 30002.

According to at least one of the First Aspect and the variants in the First Aspect, it can solve the above-mentioned problem.

For example, at least one of the First Aspect and the variants in the First Aspect can solve the problem that the above-mentioned service requirement has not been supported by the 5GS yet.

For example, at least one of the First Aspect and the variants in the First Aspect can solve the problem that there is no mechanism in the 3GPP specification(s) for achieving the above-mentioned service requirement.

For example, at least one of the First Aspect and the variants in the First Aspect can solve the problem that if the 5GS does not support the multi-path for indirect network connections, the Remote UE (or the remote UE) cannot avoid a sudden disruption or disconnection for any connectivity services over the indirect network connection due to unstable communication over single connection between the Remote UE and the Network Relay UE.

For example, at least one of the First Aspect and the variants in the First Aspect can solve the problem that user experience for the indirect network connection suffers from an unstable connection over single connection between the Remote UE and the Network Relay UE.

For example, according to at least one of the First Aspect and the variants in the First Aspect, the procedures for achieving the multi-path indirect network connections (e.g., the enhanced Multi Access-PDU (MA PDU) Session) are disclosed and the Remote UE can establish the multi-path indirect network connections. Therefore, it can solve the above-mentioned problem.

### (Second Aspect)

This aspect discloses mechanisms to configure multi-path for indirect network connections using multiple Network Relay UEs by establishing multiple PDU sessions between a Remote UE and its anchor UPF. This functionality may be called as an enhanced PDU Session for Multi-path indirect network communication.

5G ProSe UE-to-Network Relay UEs 300 enable multi-path indirect communication connections between the 5G core network (5GC) and a Remote UE 310. The multi-path indirect communication connections provide high resiliency for data connectivity (e.g., data connectivity can be maintained for UEs in a case where UEs become out of coverage from a connected single Network Relay UE.).

### (First Example of the Second Aspect)

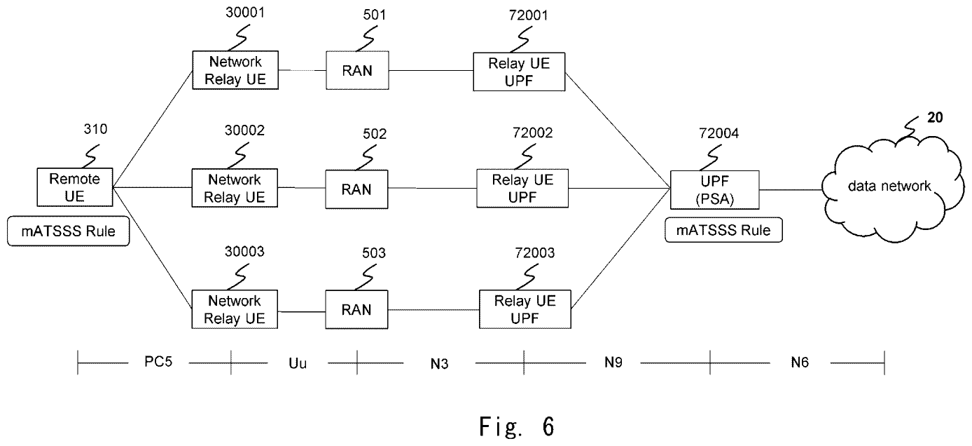

FIG. 6 includes the reference architecture that supports multi-path indirect network connections between the Remote UE 310 and 5GC in both inter-PLMN and non-roaming/roaming scenarios. FIG. 6 shows a network connection model that supports the multi-path indirect network connections using multiple PDU

Sessions. The multi-path indirect network connections provide a data communication path between the Remote UE 310 and the AF 201 in the data network 20.

Multi-path indirect network communication is a one mode of network communication, where there are multiple connection paths, e.g., between the Remote UE 310 and the UPF (PSA) 72004 through a Network Relay UE 30001, a RAN 501 and a Relay UE UPF 72001, between the Remote UE 310 and the UPF (PSA) 72004 through a Network Relay UE 30002, a RAN 502 and a Relay UE UPF 72002, between the Remote UE 310 and the UPF (PSA) 72004 through a Network Relay UE 30003, a RAN 503 and a Relay UE UPF 72003.

The UPF (PSA) 72004 is an anchor UPF for the Multi-path indirect network communication and the UPF (PAS) 72004 includes an enhanced ATSSS for multiple PDU session Rule for performing or maintaining the multi-path indirect network communication. The enhanced ATSSS for multiple PDU session Rule may be called as mATSSS Rule.

In one example, the Remote UE 310 may connect to a RAN 5 directly over the Uu interface to configure a multi-path indirect network connection while other connections may be established via Network Relay UE 300 and RAN 5.

The mATSSS Rule is used to structure and maintain the multi-path indirect network communication as similar way in the disclosure of the First aspect. For example, the mATSSS Rule may be used in the same manner to the eATSSS Rule.

The main difference between the First aspect and the Second aspect is that while the First aspect uses only one PDU Session ID for MA PDU Session (or eMA PDU Session) and only one end user IP address to structure the multi-path indirect network communication, the Second aspect uses multiple independent PDU Sessions, i.e., multiple PDU Session IDs and associated multiple end user IP addresses to structure the multi-path indirect network communication.

The mATSSS Rule is installed in both the Remote UE 310 and the UPF (PSA) 72004.

In addition to the eATSSS Rule, the mATSSS Rule takes care of multiple independent PDU Sessions to be used for the multi-path indirect network communication by an enhanced ATSSS-LL for multiple PDU Sessions functionality. The mATSSS Rule may include the mATSSS Rule. For example, the mATSSS Rule may be used for achieving an enhanced ATSSS-LL for multiple PDU Sessions functionality. For example, the mATSSS Rule may be related to the enhanced ATSSS-LL for multiple PDU Sessions functionality. The enhanced ATSSS-LL for multiple PDU Sessions functionality includes at least one of the following functionalities.

The similar functionality to eATSSS-LL functionality in the Remote UE 310. The Remote UE 310 performs at least one of the Multi-Active-Standby, Smallest Delay, Load-Balancing and Priority-based for uplink user packet handling among multiple established PDU Sessions based on the mATSSS Rule, i.e., eATSSS-LL functionality may be applied to multiple PDU Sessions.

NAT (Network Address Translation) functionality in the Remote UE 310. The Remote UE 310 maintains a representative end user IP address for the multi-path indirect network connections. The representative end user IP address represents a unique end user IP address to an application in the Remote UE 310 for the multi-path indirect network communication. In a case where the Remote UE 310 receives a downlink packet from any of associated PDU Session, the Remote UE 310 performs the NAT functionality to swap a received end user IP address with the representative end user IP address and forwards the downlink data (e.g., the downlink packet) to the application in the Remote UE 310. By using this NAT functionality, the application in the Remote UE 310 can see a single instance of IP connectivity with the AF 201 in the data network 20.

The similar functionality to ATSSS-LL functionality in the UPF (PSA) 72004. The UPF (PSA) 72004 performs at least one of the Multi-Active-Standby, Smallest Delay, Load-Balancing and Priority-based for downlink user packet handling among multiple established PDU Sessions based on the mATSSS Rule. This functionality may be called as the Downlink Classifier for downlink data handling, i.e., eATSSS-LL functionality may be applied to multiple PDU Sessions. By using the Downlink Classifier functionality, downlink data coming from the AF 201 in the data network 20 can be distributed to multiple established PDU Sessions.
NAT functionality in the UPF (PSA) 72004. The UPF (PSA) 72004 maintains a representative end user IP address for the multi-path indirect network connections. The representative end user IP address represents a unique end user IP address to the AF 201 in the data network 20 for the multi-path indirect network communication. In a case where the UPF (PSA) 72004 receives an uplink packet from any of associated PDU Session, the UPF (PSA) 72004 performs the NAT functionality to swap a received end user IP address with the representative end user IP address and forwards the uplink data (e.g., the uplink packet) to the AF 201 in the data network 20. By using this NAT functionality, the AF 201 in the data network 20 can see a single instance of IP connectivity with the Remote UE 310.

In one example, the RAN 501 can directly connect to the UPF (PSA) 72004 without the Relay UE UPF 72001. In one example, the RAN 502 can directly connect to the UPF (PSA) 72004 without the Relay UE UPF 72002. In one example, the RAN 503 can directly connect to the UPF (PSA) 72004 without the Relay UE UPF 72003. In another example, the RAN 501, the RAN 502 and RAN 503 can directly connect to the UPF (PSA) 72004 without the Relay UE UPF 72001, the Relay UE UPF 72002 and the Relay UE UPF 72003.

As shown in FIG. 6, the Remote UE 310 has established multiple indirect network communication paths to the 5GC. The Remote UE 310 and Network Relay UEs 30001, 30002, 30003 may belong to the same PLMN or different PLMNs and even two or more Network Relay UEs 30001, 30002, 30003 may belong to different PLMNs. The Remote UE 310 may also be in a roaming location and N3IWF can be used to connect Remote UE 310 with its HPLMN if the Remote UE 310 is in VPLMN.

The Remote UE 310 may be connected with two or multiple RANs 5 simultaneously using Multi-connectivity as defined in 3GPP TS 37.340 (NPL 8). For example, the RAN 501 can be a Master Node (MN) while the RAN 502 can be a Secondary Node (SN) for the multi-path indirect network communication. In this case, the UPF 72001 and the UPF 72002 can be the same UPF 72.

The Core Network entities (including e.g., AMF 70, SMF 71, UPF 72 etc.) serving the Remote UE 310 may be the same as the Core Network entities for the Network Relay UE 300. The Core Network entities (including e.g., AMF 70, SMF 71, UPF 72 etc.) serving the Remote UE 310 may be different from the Core Network entities for the Network Relay UE 300. The RAN 5 can be used by multiple different Layer 3 UE-to-Network Relays to the network. The RAN 5 can be shared by 5GCs via Multi-Operator Core Network. The UPF 72 may include the UPF 72001, the UPF 72002, the UPF 72003, UPF 72004 etc.

The reference architecture supports to create multiple PDU Sessions between the Remote UE 310 and the UPF (PAS) 72004 using the Relay UE UPF 72001, the Relay UE UPF 72002 and the Relay UE UPF 72003. The mATSSS functionality can be used to route the user traffic through multiple indirect network communication paths between Remote UE 310 and the UPF (PSA) 72004.

The Relay UE UPF 72001, Relay UE UPF 72002 and Relay UE UPF 72003 may be connected to one or more UPF (PSA) s 72004 per a UE-to-Network Relay connection. The UE-to-Network Relay connection may be established per a Relay Service Code (RSC). The UE-to-Network Relay connection may be established per a DNN and/or S-NSSAI. The expression “A and/or B” may mean “at least one of A and B” in this disclosure.

The enhanced Access Traffic Steering, Switching, Splitting (ATSSS) functionality for Multiple PDU Sessions may be called as other ways, for example, ATSSS for multi-path indirect network connections for Multiple PDU Sessions, Multi Path ATSSS (mMPATSSS), enhanced ATSSS for Multiple PDU Sessions (mATSSS), mATSSS functionality and etc.

A capability of the enhanced ATSSS functionality for Multiple PDU Sessions in the SMF 71 and the UPF 72 (e.g., the UPF 72001, the UPF 72002, the UPF 72003, UPF 72004 etc) can be expressed as enhanced ATSSS capability for Multiple PDU Sessions. The enhanced ATSSS capability for Multiple PDU Sessions may be called as other ways, for example, mATSSS capability and etc.

The capability of the enhanced ATSSS functionality for Multiple PDU Sessions may indicate that the SMF 71 or the UPF 72 (e.g., the UPF 72001, the UPF 72002, the UPF 72003, UPF 72004 etc) supports the enhanced ATSSS functionality for Multiple PDU Sessions.

The capability of the enhanced ATSSS functionality for Multiple PDU Sessions may indicate that the SMF 71 or the UPF 72 (e.g., the UPF 72001, the UPF 72002, the UPF 72003, UPF 72004 etc) is able to perform appropriate process(es) using the mATSSS Rule.

The capability of the enhanced ATSSS functionality for Multiple PDU Sessions may indicate that the SMF 71 or the UPF 72 (e.g., the UPF 72001, the UPF 72002, the UPF 72003, UPF 72004 etc) is able to perform at least the above-mentioned enhanced ATSSS-LL for multiple PDU Sessions functionality using the mATSSS Rule.

The capability of the enhanced ATSSS functionality for Multiple PDU Sessions may indicate that the SMF 71 or the UPF 72 (e.g., the UPF 72001, the UPF 72002, the UPF 72003, UPF 72004 etc) is able to perform communication in multi-path indirect network connections.

The capability of the enhanced ATSSS functionality for Multiple PDU Sessions may indicate that the SMF 71 or the UPF 72 (e.g., the UPF 72001, the UPF 72002, the UPF 72003, UPF 72004 etc) is able to perform communication in multi-path indirect network connections using at least one of the mATSSS Rule and the mATSSS functionality and the enhanced ATSSS-LL for multiple PDU Sessions functionality.

For example, at least one of the Remote UE 310, the SMF 71 and the UPF 72 (e.g., the UPF 72001, the UPF 72002, the UPF 72003, UPF 72004 etc) may handle or perform at least the above-mentioned enhanced ATSSS-LL for multiple PDU Sessions functionality using the mATSSS Rule.

For example, at least one of the Remote UE 310, the SMF 71 and the UPF 72 (e.g., the UPF 72001, the UPF 72002, the UPF 72003, UPF 72004 etc) may perform communication in multi-path indirect network connections using at least one of the mATSSS Rule and the enhanced ATSSS-LL for multiple PDU Sessions functionality.

The at least one of the Remote UE 310 and the SMF 71 and the UPF 72 (e.g., the UPF 72001, the UPF 72002, the UPF 72003, UPF 72004 etc) may store the mATSSS Rule.

The at least one of the Remote UE 310 and the SMF 71 and the UPF 72 (e.g., the UPF 72001, the UPF 72002, the UPF 72003, UPF 72004 etc) may store the mATSSS Rule in advance.

The at least one of the Remote UE 310 and the SMF 71 and the UPF 72 may receive the mATSSS Rule in advance from other network node(s).

For example, at least one of the Remote UE 310, the SMF 71 and the UPF 72 may determine which path is used for the communication based on the mATSSS Rule.

For example, in a case where there are three multi-path indirect network connections (e.g., a first connection or path via the Network Relay UE 30001, a second connection or path via the Network Relay UE 30002 and a third connection or path via the Network Relay UE 30003), at least one of the Remote UE 310, the SMF 71 and the UPF 72 may determine one of the connections or paths used for the communication based on the mATSSS Rule.

A policy of the enhanced ATSSS for Multiple PDU Sessions functionality in the PCF 73 can be expressed as enhanced ATSSS policy for Multiple PDU Sessions. The enhanced ATSSS policy for Multiple PDU Sessions may be called as other ways, for example, mATSSS policy and etc.

The enhanced ATSSS-LL for Multiple PDU Sessions functionality may be called as other ways, for example, ATSSS-LL for multi-path indirect network connections for Multiple PDU Sessions, Multi Path ATSSS-LL (mMPATSSS-LL), Enhanced ATSSS-LL for Multiple PDU Sessions (mATSSS-LL), an enhanced ATSSS-LL functionality for Multiple PDU Sessions, mATSSS-LL functionality and etc.

The enhanced ATSSS Rule for Multiple PDU Sessions functionality may be called as other ways, for example, ATSSS Rule for multi-path indirect network connections for Multiple PDU Sessions functionality, meATSSS Rule, Multi Path ATSSS for Multiple PDU Sessions functionality Rule (mMPATSSS Rule), enhanced STSSS Rule for Multiple PDU Sessions functionality (mATSSS Rule), mATSSS Rule and etc.

The enhanced PDU Session for Multi-path indirect network communication may be called as other ways, for example, PDU Session for Multi-path indirect network communication (mPDU Session) and etc.

The communication in the multi-path indirect network connections multi-path indirect network connections or the communication performed in the multi-path indirect network connections may include communication on or via or over or in or using the mPDU Session.

The enhanced Access Traffic Steering, Switching, Splitting (ATSSS) functionality for Multiple PDU Sessions may include the enhanced ATSSS-LL for Multiple PDU Sessions functionality.

The enhanced ATSSS-LL for Multiple PDU Sessions functionality may include the enhanced Access Traffic Steering, Switching, Splitting (ATSSS) functionality for Multiple PDU Sessions.

The mATSSS Rule may be used for at least one of the enhanced Access Traffic Steering, Switching, Splitting (ATSSS) functionality for Multiple PDU Sessions and the enhanced ATSSS-LL for Multiple PDU Sessions functionality.

The enhanced ATSSS Rule may be a rule used for at least one of the enhanced Access Traffic Steering, Switching, Splitting (ATSSS) functionality for Multiple PDU Sessions and the enhanced ATSSS-LL for Multiple PDU Sessions functionality.

### Second Example of the Second Aspect

The Second example of the Second Aspect discloses the Registration Procedure for the Remote UE 310 supporting the mPDU Session.

FIG. 2 in the Second example of the First Aspect is used for the Registration Procedure for the Remote UE 310 supporting the mPDU Session with the following modifications.

The Multi path relay capability in step 1 in FIG. 2 indicates that the Remote UE 310 supports handling of the mPDU Session. The Multi path relay capability may be replaced with the mATSSS capability. The mATSSS capability may be used instead of the Multi path relay capability. The mATSSS capability may indicate that the Remote UE 310 supports multi-path indirect network connections. The mATSSS capability may indicate that the Remote UE 310 supports connection via the Network Relay UE 30001, connection via the Network Relay UE 30002 and connection via the Network Relay UE 30003 as illustrated in FIG. 6.

The eMA PDU subscribed in step 4 and step 5 in FIG. 2 can be replaced with an mPDU Session subscribed. The mPDU Session subscribed may be used instead of the eMA PDU subscribed. The mPDU Session subscribed indicates that the Remote UE 310 is allowed to establish mPDU Session as subscriber data. The mPDU Session subscribed indicates that the Remote UE 310 is allowed to establish the mPDU Session. The mPDU Session subscribed may exist per S-NSSAI in the Subscribed NSSAI. The mPDU Session subscribed may indicate that the Remote UE 310 is allowed to communicate on or via or over or using the mPDU Session. The mPDU Session subscribed may indicate that the Remote UE 310 is allowed to communicate using multi-path indirect network connections.

### Third Example of the Second Aspect

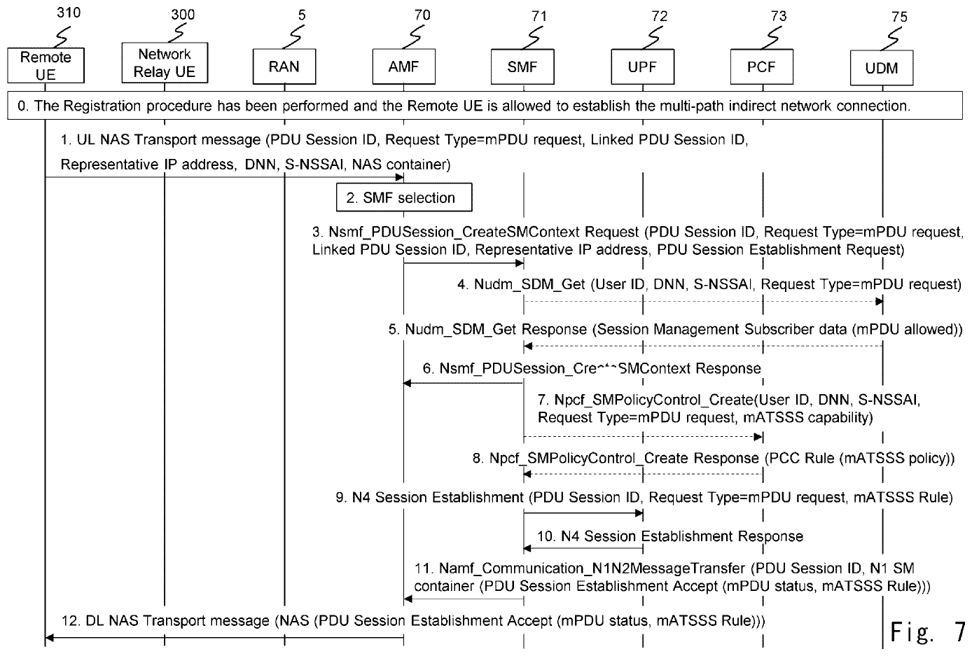

FIG. 7 includes an example of the PDU Session establishment procedure for the multi-path indirect network connections using multiple PDU Sessions.

In order to configure the mPDU session using multiple Network Relay UEs 300, the Remote UE 310 needs to repeat the PDU Session establishment procedure in FIG. 5 multiple times as many as the Remote UE 310 duplicates the PC5 connections for the mPDU session.

As the mATSSS Rule is configured to both the Remote UE 310 and the UPF 72 by this procedure, User data between the Remote UE 310 and the AF 201 in the data network 20 is handled according to the mATSSS Rule in both the Remote UE 310 and the UPF 72 and results reliable user data transmission over the PC5 interface. The procedure to establish the multi-path indirect network connections is illustrated in the Fourth example of the Second Aspect.

The detailed processes of the Third example of the Second Aspect are described below with reference to FIG. 7.

In FIG. 7, the UPF 72 represents the UPF (PSA) 72004 in FIG. 6 and the Relay UE UPF 72001, the Relay UE UPF 72002 and the Relay UE UPF 72003 are not shown as they are combined to UPF (PSA) 72004 or the Relay UE UPF 72001, the Relay UE UPF 72002 and the Relay UE UPF 72003 are not needed as RAN 501, RAN 502 and RAN 503 directly connect to the UPF (PSA) 72004. For example, the Relay UE UPF 72001, the Relay UE UPF 72002 and the Relay UE UPF 72003 and the UPF (PSA) 72004 may be deployed separately in the same manner as FIG. 6. In this case, communication with the UPF (PSA) 72004 may be performed via at least one of the Relay UE UPF 72001, the Relay UE UPF 72002 and the Relay UE UPF 72003.

Step 0. A communication path between the Remote UE 310 and the Network Relay UE 300 over PC5 interface has been established in accordance with 3GPP TS 23.304 (NPL 7). The Registration procedure has been performed by the Network Relay UE 300 successfully and the Remote UE 310 is allowed to establish the multi-path indirect network connections. For example, in step 0, the Remote UE 310 may be registered by performing the process(es) in the Second example of the Second Aspect. For example, the Network Relay UE 300 may be the Network Relay UE 30001, the Network Relay UE 30002 or the Network Relay UE 30003 as illustrated in FIG. 6.

Step 1. The Remote UE 310 sends a UL NAS Transport message to the AMF 70 including at least one of PDU Session ID, Request Type which is set to mPDU request, Linked PDU Session ID, Representative IP address, DNN, S-NSSAI and NAS container. The NAS container may include a PDU Session Establishment Request message, a Service Request message or any other NAS message with the purpose of establishing an mPDU Session or with the purpose to add new PDU

Session to the already established mPDU Session. For example, in a case where the Remote UE 310 receives the mPDU Session subscribed, the Remote UE 310 may send the UL NAS Transport message.

The following bullets explain each parameter in details.
PDU Session ID: Refer to step 1 in the Third example of the First Aspect.
Request Type which is set to mPDU request indicates that the Remote UE 310 requests to establish the mPDU session. Request Type which is set to mPDU request may be expressed as “Request Type=mPDU request”. Request Type which is set to mPDU request may indicate that the Remote UE 310 requests to communicate on or via or over or using the mPDU session. Request Type which is set to mPDU request may indicate that the Remote UE 310 requests to communicate using the multi-path indirect network connections. Request Type which is set to mPDU request may indicate that the Remote UE 310 requests to establish the multi-path indirect network connections.
Linked PDU Session ID indicates that the PDU Session ID that represents the mPDU Session. The Linked PDU Session ID may be most likely the PDU Session ID of the first PDU Session ID for the mPDU Session. The Linked PDU Session ID may be the PDU Session ID of the first PDU Session ID for the mPDU Session. The Linked PDU Session ID may be the PDU Session ID for the mPDU Session. The Linked PDU Session ID may be the PDU Session ID for communication in multi-path indirect network connections. If there is no existing PDU Session ID for mPDU Session (e.g., it is very first PDU Session to configure the mPDU Session), the Linked PDU Session ID is not included.

Representative IP address indicates that the end user IP address that has been assigned for the Remote UE 310 for the mPDU Session. The end user IP address may be assigned in step 0. The Representative IP address represents the Remote UE 310 in a case where the Remote UE 310 communicates with the AF 201 in the data network 20. The Representative IP address also represents the Remote UE 310 in a case where the Remote UE 310 communicates with the Application in the Remote UE 310. The Representative IP address may be the end user IP address for the mPDU Session. The Representative IP address may be the end user IP address for communication in multi-path indirect network connections.
DNN: Refer to step 1 in the Third example of the First Aspect.
S-NSSAI: Refer to step 1 in the Third example of the First Aspect.

In one example, the PDU Session Establishment Request message, Service Request message or any other NAS message embedded in the UL NAS Transport message may include the Request Type which is set to mPDU request.

The Remote UE 310 may send the UL NAS Transport message during the PDU Session Establishment procedure.

Step 2. Upon reception of the UL NAS Transport message from the Remote UE 310, the AMF 70 performs the SMF selection. For example, the AMF 70 may perform the SMF selection based on at least one of the received Request Type which is set to mPDU request, Linked PDU Session ID, Representative IP address, S-NSSAI, DNN from the Remote UE 310. An SMF 71 to be chosen and associated UPF 72 with the SMF 71 have to have an mATSSS capability.

For example, the AMF 70 may store information indicating at least one of SMF and UPF associated with the SMF which have the mATSSS capability. For example, based on the stored information, the AMF 70 may select at least one of the SMF 71 and the UPF 72 which have the mATSSS capability. For example, in a case where the AMF 70 receives the Request Type which is set to mPDU request, the AMF 70 may select, based on the stored information, at least one of the SMF 71 and the UPF 72 which have the mATSSS capability. For example, the AMF 70 may receive the information indicating at least one of SMF and UPF associated with the SMF which have the mATSSS capability from other network node(s). For example, the AMF 70 may know which SMF and UPF have the mATSSS capability in advance.

If the Linked PDU Session ID is received, the AMF 70 chooses the SMF 71 that the Remote UE 310 has been associated with the PDU Session in the Linked PDU Session ID. For example, in a case where the Linked PDU Session ID is received, the AMF 70 may choose the SMF 71 that is associated with the PDU Session identified by the Linked PDU Session ID. For example, in a case where the Linked PDU Session ID is received, the AMF 70 may choose the SMF 71 that is associated with the Linked PDU Session ID. In this way, the same SMF 71 that manages mPDU Session is correctly chosen by the AMF 70.

The AMF 70 may store information indicating relationship between SMF(s) and PDU Session(s) (or PDU Session ID(s)), and based on the store information the AMF 70 may choose the SMF 71 that is associated with the PDU Session identified by the Linked PDU Session ID.

Step 3. Once the SMF 71 is chosen, the AMF 70 sends an Nsmf_PDUSession_CreateSMContext Request message to the SMF 71 including at least one of the PDU Session ID, the Request Type which is set to mPDU request, the Linked PDU Session ID, the Representative IP address and NAS message containing the PDU Session Establishment Request message.

The NAS message may include the Service Request message or the any other NAS message mentioned in step 1 instead of or in addition to the PDU Session Establishment Request message.

The Nsmf_PDUSession_CreateSMContext Request message may include at least one of User ID (the User ID may be set with SUPI for the Remote UE 310), the DNN and the S-NSSAI.

PDU Session ID, DNN, S-NSSAI, Request Type which is set to mPDU request and PDU Session Establishment Request message in step 3 may be same ones in step 1.

Step 4. In a case where the SMF 71 does not hold the Session Management Subscriber data, the SMF 71 may send an Nudm_SDM_Get message to the UDM 75 including at least one of User ID, DNN, S-NSSAI, and Request Type which is set to mPDU request. The User ID may be set with SUPI. The User ID may be set with SUPI for the Remote UE 310. See step 1 for detail of DNN, S-NSSAI, Request Type which is set to mPDU request. DNN, S-NSSAI, Request Type which is set to mPDU request in step 4 may be same ones in step 1.

Step 5. Upon reception of the Nudm_SDM_Get message from the SMF 71, the UDM 75 may send an Nudm_SDM_Get Response message to the SMF 71 including the Session Management Subscriber data. The Session Management Subscriber data may include mPDU allowed. The mPDU allowed indicates that the Remote UE 310 is allowed to establish mPDU Session to at least one of the DNN and S-NSSAI as indicated in the Nudm_SDM_Get message in step 4.

The mPDU allowed may indicate that the Remote UE 310 is allowed to establish mPDU Session. The mPDU allowed may indicate that the Remote UE 310 is allowed to establish communication on or via or over or using the mPDU Session. The mPDU allowed may indicate that the Remote UE 310 is allowed to establish communication using multi-path indirect network connections.

The mPDU allowed may also indicate that the maximum number of PC5 connections that the Remote UE 310 can establish to at least one of the DNN and S-NSSAI. The maximum number of PC5 connections is referred by the SMF 71 in a case where the SMF 71 receives a request from the Remote UE 310 to add more PDU Session to the established mPDU Session. If the request is an attempt to equal or exceed the maximum number of PC5 connections, the SMF 71 rejects this request and sends an SM reject message to the Remote UE 310. For example, if the request is an attempt to equal or exceed the maximum number of PC5 connections, the SMF 71 rejects this request and sends an SM reject message to the Remote UE 310 with the cause. The cause may indicate that the request is an attempt to equal or exceed the maximum number of PC5 connections. The cause may indicate that the request is rejected because the request is an attempt to equal or exceed the maximum number of PC5 connections.

For example, in a case where the SMF 71 determines that it will reach the maximum number of PC5 connections for the Remote UE 310 by the request, the SMF 71 may reject this request and send the SM reject message to the Remote UE 310.

For example, in a case where the SMF 71 determines that the current number of PC5 connections for the Remote UE 310 will be equal to or will exceed the maximum number of PC5 connections if the PC5 connection is established by the request, the SMF 71 may reject this request and send the SM reject message to the Remote UE 310.

Step 6. The SMF 71 sends an Nsmf_PDUSession_CreateSMContext Response message to the AMF 70.

For example, in a case where the SMF 71 receives the Nsmf_PDUSession_CreateSMContext Request message and has already the Session Management Subscriber data, the SMF 71 may not send the Nudm_SDM_Get message. In this case the SMF 71 may send the Nsmf_PDUSession_CreateSMContext Response after receiving the Nsmf_PDUSession_CreateSMContext Request message.

Step 7. In a case where the SMF 71 does not have PCF association, the SMF 71 may send an Npcf_SMPolicyControl_Create message to the PCF 73 including at least one of User ID, DNN, S-NSSAI, Request Type which is set to mPDU request and mATSSS capability. The User ID may be set with SUPI. The User ID may be set with SUPI for the Remote UE 310. The mATSSS capability indicates a capability of at least one of the SMF 71 and associated UPF 72 for handling of mATSSS functionality.

For example, the mATSSS capability may indicate that at least one of the SMF71 and the UPF 72 supports the enhanced ATSSS functionality for Multiple PDU Sessions.

See step 1 for detail of DNN, S-NSSAI, Request Type which is set to mPDU request.

DNN, S-NSSAI, Request Type which is set to mPDU request in step 7 may be same ones in step 1.

User ID, DNN, S-NSSAI, Request Type which is set to mPDU request in step 7 may be same ones sent in step 4.

For example, in a case where the SMF 71 has PCF association or has mATSSS policy (e.g., mATSSS policy for the Remote UE 310), the SMF 71 may not perform step 7.

Step 8. Upon reception of the Npcf_SMPolicy Control_Create message from the SMF 71, the PCF 73 may examine the request and provide the mATSSS policy. The mATSSS policy may be included in PCC Rule. The PCF 73 may make the mATSSS policy. The mATSSS policy is made based on the mATSSS capability and Subscription data. The Subscription data may be for the Remote UE 310. The PCF 73 may make the mATSSS policy based on local policy or local configuration in the PCF 73. Note that the PCF 73 may have downloaded the Subscription data for the Remote UE 310 from the UDM 75 in advance. The mATSSS policy may be a policy for at least one of the mATSSS, the mATSSS functionality and the mATSSS-LL functionality.

The mATSSS policy may include the mPDU allowed. The PCC Rule may include the mPDU allowed. See step 5 for detail of the mPDU allowed.

For example, in a case where the Subscription data includes information indicating the Remote UE 310 is allowed to establish mPDU Session to at least one of the DNN and S-NSSAI as indicated in the Npcf_SMPolicy Control_Create message in step 7 and the PCF 73 receives the mATSSS capability, the PCF 73 may make or generate the mATSSS policy including the mPDU allowed.

For example, in a case where the Subscription data includes information indicating the Remote UE 310 is allowed to establish mPDU Session and the PCF 73 receives the mATSSS capability, the PCF 73 may make or generate the mATSSS policy including the mPDU allowed.

For example, in a case where the Subscription data includes the Multi path relay capability or the mATSSS capability regarding the Remote UE 310 and the PCF 73 receives the mATSSS capability, the PCF 73 may make or generate the mATSSS policy including the mPDU allowed.

For example, the mATSSS policy may include information for generating the mATSSS Rule. For example, the mATSSS policy may include information for determining the percentage of the SDF traffic that is sent over each 3GPP accesses. This information may be used for determining “Load-Balancing” Rule in the mATSSS Rule. For example, the mATSSS policy may include information for determining the priority for each 3GPP accesses. This information may be used for “Priority-based” Rule in the mATSSS Rule. For example, the mATSSS policy may include information for sharing/transmitting the same Remote UE SDF traffic that is sent via different independent PDU Sessions over multiple 3GPP/non-3GPP accesses.

The SMF 71 generates at least one of the mATSSS Rule and N4 rule for the UPF 72 based on the received mATSSS policy from the PCF 73. The mATSSS Rule may be included in the N4 rule. Alternatively, the N4 rule may be included in the mATSSS Rule.

For example, the SMF 71 may generate the mATSSS Rule based on local policy or local configuration in the SMF 71.

For example, the SMF 71 may generate the mATSSS Rule based on at least one of the received mATSSS policy and local policy and local configuration in the SMF 71.

For example, the SMF 71 may generate the mATSSS Rule based on the above-mentioned information in the mATSSS policy. The above-mentioned information in the mATSSS policy may be stored in the SMF 71 in advance.

For example, the mATSSS Rule may include the mATSSS policy. For example, the SMF 71 may generate the mATSSS Rule by including the mATSSS policy to the mATSSS Rule.

Step 9. The SMF 71 sends an N4 Session Establishment message to the UPF 72 including at least one of the PDU Session ID, the Request Type which is set to mPDU request, the Linked PDU Session ID, the Representative IP address and the mATSSS Rule in order to reserve user plane resources for the mPDU Session and install the mATSSS rule.

In a case where the UPF 72 receives the Linked PDU Session ID, it means that there may be one or multiple PDU Session(s) that configure the mPDU Session. In this case, the UPF 72 finds all associated PDU Sessions and enforces the mATSSS-LL functionality among associated PDU Sessions.

In a case where the UPF 72 receives the Representative IP address, the UPF 72 enforces the NAT functionality for uplink user data sent from the Remote UE 310. As the uplink user data (e.g., a user IP packet) has source IP address set with a unique IP address assigned to this PDU Session, the UPF 72 replaces the source IP address of the user IP packet with the Representative IP address. By using this NAT functionality in the UPF 72, the AF 201 in the data network 20 receives the uplink user data from the Remote UE 310 constantly with the same source IP address (e.g., Representative IP address).

Step 10. After successful resource reservation for the mPDU Session and successful installation of the mATSSS Rule, the UPF 72 sends an N4 Session Establishment Response message to the SMF 71.

Step 11. The SMF 71 sends an Namf_Communication_NIN2Message Transfer message to the AMF 70 including N1 SM container. The N1 SM container contains a PDU Session Establishment Accept message, a Service Accept message or any other NAS message. The PDU Session Establishment Accept message or other SM message (e.g., Service Accept message or any other NAS message) includes mPDU status and the mATSSS Rule. The mPDU status indicates that a status of the mPDU session indicating whether 5GS (e.g., network) accepts the request to establish the mPDU Session.

The mPDU status may indicate whether 5GS accepts the request to establish the mPDU Session. The mPDU status may indicate that 5GS accepts the request to establish the mPDU Session.

For example, the SMF 71 may configure the mPDU status indicating whether 5GS accepts the request to establish the mPDU Session based on local policy in the SMF 71. For example, the SMF 71 may configure the mPDU status indicating that 5GS accepts the request to establish the mPDU Session in a case where steps 4 to 10 are completed successfully. For example, the SMF 71 may configure the mPDU status indicating that 5GS accepts the request to establish the mPDU Session in a case where the current number of PC5 connections for the Remote UE 310 will not be equal to or will not exceed the maximum number of PC5 connections (the maximum number may be one mentioned in step 5) if the PC5 connection is established by the request.

The mPDU status may also indicate that the maximum number of PC5 connections that the Remote UE 310 can establish to at least one of the DNN and S-NSSAI. The maximum number of PC5 connections is stored and referred by the Remote UE 310 in a case where the Remote UE 310 adds more PDU Session to the established mPDU Session. The Remote UE 310 may request to add more PDU Session to the established mPDU Session up to the received maximum number of PC5 connections. The SMF 71 may send the mPDU status to the UPF 72. The SMF 71 may generate and send the mPDU status to the UPF 72 in step 9.

The mPDU status may indicate that 5GS does not accept the request to establish the mPDU Session. The mPDU status indicating that 5GS does not accept the request to establish the mPDU Session may be included in the SM reject message sent to the Remote UE 310 mentioned in step 5. The mPDU status indicating that 5GS does not accept the request to establish the mPDU Session may be included in a reject message (e.g., a PDU Session Establishment Reject message) sent to the Remote UE 310. For example, the PDU Session Establishment Reject message may be included in the N1 SM container.

For example, the SMF 71 may configure the mPDU status indicating that 5GS does not accept the request to establish the mPDU Session in a case where steps 4 to 10 are not completed successfully. For example, the SMF 71 may configure the mPDU status indicating that 5GS does not accept the request to establish the mPDU Session in a case where the current number of PC5 connections for the Remote UE 310 will be equal to or will exceed the maximum number of PC5 connections (the maximum number may be one mentioned in step 5) if the PC5 connection is established by the request.

Step 12. The AMF 70 sends a DL NAS Transport message to the Remote UE 310 including the PDU Session Establishment Accept message, the Service Accept message or any other NAS message. The PDU Session Establishment Accept message or other SM message (e.g., Service Accept message or any other NAS message) includes the mPDU status and the mATSSS Rule. See step 11 for detail of the mPDU status and the mATSSS Rule.

After successful PDU Session Establishment procedure, the Remote UE 310 obtains the end user IP address for the PDU Session (e.g., for the mPDU Session). For example, the end user IP address can be informed by the NAS message in step 12 or after performing the DNS Query with the UPF 72.

If the Remote UE 310 holds the Representative IP address other than the assigned IP address by this PDU Session Establishment procedure for the PDU Session, the Remote UE 310 enforces the NAT functionality for downlink user data sent from the UPF 72. As the downlink user data may have destination IP address set with a unique IP address assigned to this PDU Session, the Remote UE 310 replaces the destination IP address of user IP packet with the Representative IP address. By using this NAT functionality in the Remote UE 310, the Application in the Remote UE 310 receives the downlink user data from the Remote UE 310 constantly with the same destination IP address (Representative IP address).

The order of steps 4 and 7 may be reversed.

### Variant 1 of Third Example of the Second Aspect

If the Remote UE 310 sends the PDU Session Establishment Request message in step 1 for adding more PC5 connection to existing mPDU Session and receives the SM reject message or the PDU Session Establishment Reject message, the Remote UE 310 does not add new PC5 connection due to rejection but the Remote UE 310 maintains already established PC5 connections for the mPDU Session. This rejection does not affect to the existing PC5 connections for the mPDU Session.

### Variant 2 of Third Example of the Second Aspect

In a case where the UPF 72 receives the Representative IP address in step 9, the UPF 72 may assign the Representative IP address to this PDU Session if the configuration in the UPF 72 allows. It results that the same IP address is assigned to each PDU Sessions that configures the mPDU Session. By using this approach, the Remote UE 310 and UPF 72 do not activate the NAT functionality and results less processing in both Remote UE 310 and UPF 72. For example, this approach may be used instead of using the NAT functionality.

### Variant 3 of Third Example of the Second Aspect

The UE Route Selection Policy (URSP) rules in clause 6.6.2.1 of TS 23.503 (NPL 5) may apply for the 5G ProSe Remote UE. The Route Selection Descriptor (RSD) in the URSP rules can be enhanced to include a new information element “ProSe Multi-PDU Sessions Preference” or “ProSe Layer-3 UE-to-Network Relay Offload with Multi-PDU Sessions” to support multiple independent PDU Sessions through different indirect connections via UE-to-Network Relay UEs 300. If an application in the Remote UE 310 or application traffic in the Remote UE 310 matches the URSP rules, then the corresponding RSD(s) can be used to evaluate the existing PDU Sessions or establish a new PDU Session.

### Fourth Example of the Second Aspect

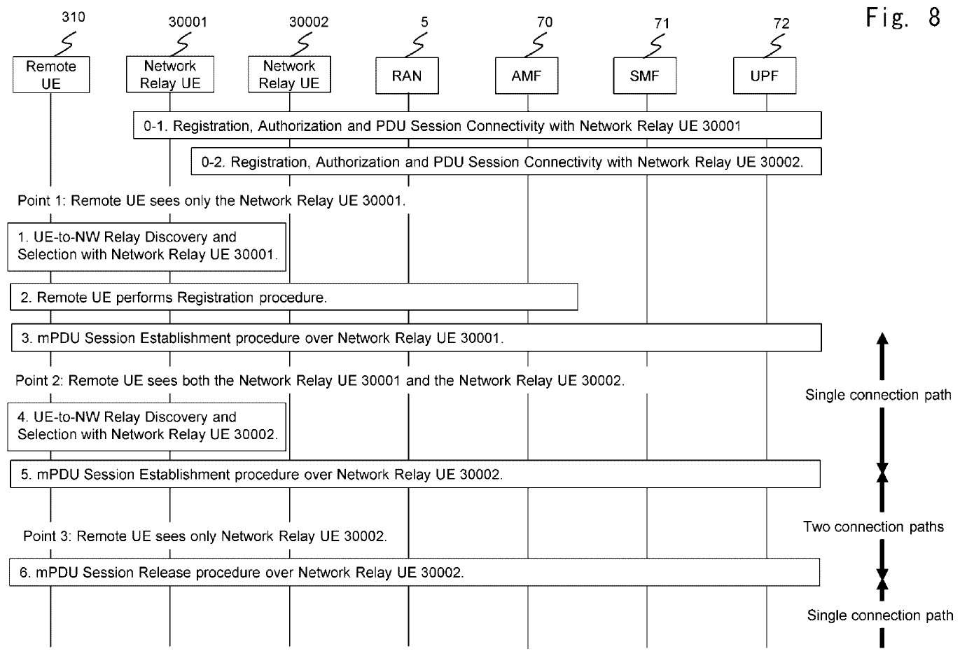

Fourth example of the Second Aspect includes how the multi-path indirect network connections can be established and updated based on a move of the Remote UE 310 using FIG. 4 in the Fourth example of the Second Aspect and FIG. 8.

Refer to FIG. 4 and associated explanatory texts as the procedure of the Fourth example of the Second Aspect as illustrated in FIG. 8 refers.

Taking this Remote UE 310 movement as an example, FIG. 8 explains how the multi-path indirect network connections are configured and returns back to a single path indirect network connection. FIG. 8 shows an example of multi-path indirect network connections using multiple PDU Sessions.

The detailed procedure of the Fourth example of the Second Aspect is described below with reference to both FIG. 4 and FIG. 8.

The following steps explains the steps in FIG. 8.

Step 0-1. The Network Relay UE 30001 performs the Registration procedure with the AMF 70 and at least one PDU Session is established with the SMF 71 and UPF 72.

Step 0-2. The Network Relay UE 30002 performs the Registration procedure with the AMF 70 and at least one PDU Session is established with the SMF 71 and UPF 72. In one example, the SMF 71 and UPF 72 may be same or different from ones for the Network Relay UE 30001.

* Point 1: The Remote UE sees only the Network Relay UE 30001:

Step 1. As the Remote UE 310 sees the signal from the Network Relay UE 30001, the Remote UE 310 performs the UE-to-NW Relay Discovery and Selection with the Network Relay UE 30001 in accordance with 3GPP TS 23.304 (NPL 7).

Step 2. After successful UE-to-NW Relay Discovery and Selection with the Network Relay UE 30001 in step 1, the Remote UE 310 initiates the Registration procedure as disclosed by the Second example of the Second Aspect.

Step 3. After successful Registration procedure, the Remote UE 310 initiates the PDU Session Establishment procedure for generating mPDU Session over or for or to the Network Relay UE 30001 as disclosed by the Third example of the Second Aspect. For example, the Linked PDU Session ID in the PDU Session Establishment procedure in step 3 may not be included in the UL NAS Transport message in step 3.

After successful PDU Session Establishment procedure, the Remote UE 310 communicates with the AF 201 in the data network 20 with single connection path between the Remote UE 310 and the UPF 72.

At this point, at least one of the Remote UE 310, AMF 70, SMF 71 and UPF 72 stores the mPDU status and mATSSS Rule for managing the multi-path indirect network connections.

At this point, the mATSSS-LL functionality is installed in both the Remote UE 310 and UPF 72.

For example, the Remote UE 310 may consider that the mATSSS-LL functionality is installed in a case where the Remote UE 310 receives at least one of the mPDU status and the mATSSS Rule. For example, the UPF 72 may consider that the mATSSS-LL functionality is installed in a case where the UPF 72 receives at least one of the mPDU status and the mATSSS Rule.

For example, the Remote UE 310 may communicate via the Network Relay UE 30001 based on the mATSSS Rule received in step 3.

For example, the Remote UE 310 may perform the mATSSS functionality or the mATSSS-LL functionality based on based on the mATSSS Rule received in step 3. * Point 2: The Remote UE sees both the Network Relay UE 30001 and the Network Relay UE 30002:

Step 4. As the Remote UE 310 sees the signal from the Network Relay UE 30002, the Remote UE 310 performs the UE-to-NW Relay Discovery and Selection with the Network Relay UE 30002 in accordance with 3GPP TS 23.304 (NPL 7). For example, the Remote UE 310 may perform the UE-to-NW Relay Discovery and Selection with the Network Relay UE 30002 while keeping the PDU session (e.g., the mPDU Session) established in step 3.

Step 5. After successful UE-to-NW Relay Discovery and Selection with the Network Relay UE 30002 in step 4, the Remote UE 310 initiates the PDU Session Establishment procedure over or for or to the Network Relay UE 30002 as disclosed by the Third example of the Second Aspect for adding one more PDU Session to the mPDU Session.

For example, the Linked PDU Session ID in the UL NAS Transport message in the PDU Session Establishment procedure of step 5 may be a PDU Session ID used in the PDU Session Establishment procedure in step 3.

For example, the Representative IP address in the UL NAS Transport message in the PDU Session Establishment procedure of step 5 may an IP address assigned in step 2.

For example, the Remote UE 310 may initiate the PDU Session Establishment procedure over or for or to the Network Relay UE 30002 while keeping the PDU session (e.g., the mPDU Session) established in step 3.

After successful Session Establishment procedure, the Remote UE 310 communicates with the AF 201 in the data network 20 with two connection paths between the Remote UE 310 and the UPF 72.

At this point, at least one of the Remote UE 310, AMF 70. SMF 71 and UPF 72 updates mPDU status and mATSSS Rule for managing the multi-path indirect network connections.

For example, at least one of the Remote UE 310, AMF 70, SMF 71 and UPF 72 may store at least one of mPDU status and mATSSS Rule generated or received in step 5. For example, at least one of the Remote UE 310, AMF 70, SMF 71 and UPF 72 may store at least one of mPDU status and mATSSS Rule generated or received in step 5 independently from the ones stored in step 3.

As two connection paths between the Remote UE 310 and the UPF 72 are established at this point, high resiliency for data connectivity can be achieved.

For example, at this point, the Remote UE 310 may communicate via the Network Relay UE 30001 and via the Network Relay UE 30002.

For example, at this point, the Remote UE 310 may communicate via the Network Relay UE 30001 and via the Network Relay UE 30002 simultaneously.

For example, the Remote UE 310 may communicate via the Network Relay UE 30001 based on at least one of the mATSSS Rule received in step 3 and the mATSSS Rule received in step 5.

For example, the Remote UE 310 may communicate via the Network Relay UE 30002 based on at least one of the mATSSS Rule received in step 3 and the mATSSS Rule received in step 5.

For example, the Remote UE 310 may perform the mATSSS functionality or the mATSSS-LL functionality based on based on at least one of the mATSSS Rule received in step 3 and the mATSSS Rule received in step 5.

In one example, if the Remote UE 310 sees the signal from the RAN 5, the Remote UE 310 may initiate the PDU Session Establishment procedure (e.g., the PDU Session Establishment procedure or the PDU Session Establishment procedure for generating mPDU Session) using Uu interface to the RAN 5. In this case, the UE-to-NW Relay Discovery and Selection in step 4 is not taken place. * Point 3: The Remote UE sees only Network Relay UE 30002:

Step 6. As the Remote UE 310 cannot maintain the communication path with the Network Relay UE 30001 over the PC5 interface for example due to weak signal strength because of distance between the Remote UE 310 and the Network Relay UE 30001, the Network Relay UE 30001 may initiate the PDU Session Release procedure as described in Section 4.3.4.2 3GPP TS 23.502 (NPL 4), e.g., triggered by the Radio Link Failure (RLF) in lower layer.

After successful PDU Session Release procedure, the Remote UE 310 communicates with the AF 201 in the data network 20 with single connection path between the Remote UE 310 and the UPF 72.

For example, the Remote UE 310 may communicate via the Network Relay UE 30002 based on the mATSSS Rule received in step 5.

For example, the Remote UE 310 may perform the mATSSS functionality or the mATSSS-LL functionality based on based on the mATSSS Rule received in step 5.

At this point, at least one of the Remote UE 310, AMF 70, SMF 71 and UPF 72 updates mPDU status and mATSSS Rule for managing the multi-path indirect network connections.

For example, during the PDU Session Release procedure or after the PDU Session Release procedure, at least one of the Remote UE 310, AMF 70, SMF 71 and UPF 72 may delete the mPDU status and the mATSSS Rule which are stored in step 3 or may replace the mPDU status and the mATSSS Rule which are stored in step 3 with the mPDU status and the mATSSS Rule which are generated or received in step 6.

For example, in case where the Remote UE 310 locates at Point 2 from the beginning (e.g., in a case where the Remote UE 310 switches on at Point 2), the Remote UE 310 may perform steps 1 to 5. In this case, the Remote UE 310 may perform steps 1 to 3 first then perform steps 4 and 5, or the Remote UE 310 may perform steps 4, 2 and 5 first then perform steps 1 and 3.

For example, the Remote UE 310 may perform the enhanced Access Traffic Steering, Switching, Splitting (ATSSS) functionality for Multiple PDU Sessions or the mATSSS-LL functionality based on the received mATSSS Rule.

For example, at Point 1 or 2, the Remote UE 310 may perform communication via the Network Relay UE 30001 (e.g., the communication includes sending uplink data) based on the received mATSSS Rule. In a case where 3GPP and non-3GPP accesses are available for the communication via the Network Relay UE 30001, the Remote UE 310 may perform the communication via the Network Relay UE 30001 on the 3GPP access or the non-3GPP access. The Remote UE 310 may determine which access is used for the communication based on the mATSSS Rule.

For example, at Point 2 or 3, the Remote UE 310 may perform communication via the Network Relay UE 30002 (e.g., the communication includes sending uplink data) based on the received mATSSS Rule. In a case where 3GPP and non-3GPP accesses are available for the communication via the Network Relay UE 30002, the Remote UE 310 may perform the communication via the Network Relay UE 30002 on the 3GPP access or the non-3GPP access. The Remote UE 310 may determine which access is used for the communication based on the mATSSS Rule.

For example, the UPF 72 (e.g., the UPF (PSA) 72004, the Relay UE UPF 72001, the Relay UE UPF 72002, the Relay UE UPF 72003 etc.) may perform the enhanced Access Traffic Steering, Switching, Splitting (ATSSS) functionality for Multiple PDU Sessions or the mATSSS-LL functionality based on the received mATSSS Rule.

For example, at Point 1 or 2, the UPF 72 (e.g., the UPF (PSA) 72004, the Relay UE UPF 72001, the Relay UE UPF 72002, the Relay UE UPF 72003 etc.) may perform communication via the Network Relay UE 30001 (e.g., the communication includes sending downlink data) based on the received mATSSS

Rule. In a case where 3GPP and non-3GPP accesses are available for the communication via the Network Relay UE 30001, the the UPF 72 (e.g., the UPF (PSA) 72004, the Relay UE UPF 72001, the Relay UE UPF 72002, the Relay UE UPF 72003 etc.) may perform the communication via the Network Relay UE 30001 on the 3GPP access or the non-3GPP access. The Remote UE 310 may determine which access is used for the communication based on the mATSSS Rule.

For example, at Point 2 or 3, the UPF 72 (e.g., the UPF (PSA) 72004, the Relay UE UPF 72001, the Relay UE UPF 72002, the Relay UE UPF 72003 etc.) may perform communication via the Network Relay UE 30002 (e.g., the communication includes sending downlink data) based on the received mATSSS Rule. In a case where 3GPP and non-3GPP accesses are available for the communication via the Network Relay UE 30002, the Remote UE 310 may perform the communication via the Network Relay UE 30002 on the 3GPP access or the non-3GPP access. The Remote UE 310 may determine which access is used for the communication based on the mATSSS Rule.

The performing the enhanced Access Traffic Steering, Switching, Splitting (ATSSS) functionality for Multiple PDU Sessions or the mATSSS-LL functionality based on the received mATSSS Rule includes the above-mentioned communication by the Remote UE 310 or by the UPF 72 (e.g., the UPF (PSA) 72004, the Relay UE UPF 72001, the Relay UE UPF 72002, the Relay UE UPF 72003 etc.).

The mATSSS Rule may be used for performing the enhanced Access Traffic Steering, Switching, Splitting (ATSSS) functionality for Multiple PDU Sessions or the mATSSS-LL functionality.

The mATSSS Rule may be information for performing the enhanced Access Traffic Steering, Switching, Splitting (ATSSS) functionality for Multiple PDU Sessions or the mATSSS-LL functionality.

The mATSSS Rule may include information for controlling the above-mentioned communication by the Remote UE 310 or by the UPF 72 (e.g., the UPF (PSA) 72004, the Relay UE UPF 72001, the Relay UE UPF 72002, the Relay UE UPF 72003 etc.).

The mATSSS Rule may be expressed as information for controlling or performing the above-mentioned communication by the Remote UE 310 or by the UPF 72 (e.g., the UPF (PSA) 72004, the Relay UE UPF 72001, the Relay UE UPF 72002, the Relay UE UPF 72003 etc.).

The mATSSS Rule may be expressed as information for controlling or performing communication in multi-path indirect network connections.

For example, multi-path indirect network connections may include the connection via or over the Network Relay UE 30001 and the connection via or over the Network Relay UE 30002.

### Variant 1 of Fourth Example of the Second Aspect

The UE Route Selection Policy (URSP) rules in clause 6.6.2.1 of TS 23.503 (NPL 5) may apply for the 5G ProSe Remote UE. The Route Selection Descriptor (RSD) in the URSP rules can be enhanced to include a new information element “ProSe Multi-path Indirect Connection Preference” or “ProSe Layer-3 UE-to-Network Relay Offload with Multi-indirect Connections” to support multiple indirect connections via UE-to-Network Relay UEs 300. If an application in the Remote UE 310 or application traffic in the Remote UE 310 matches the URSP rules, then the corresponding RSD(s) can be used to establish a new indirect connection via UE-to-Network Relay UE 300 and a new PDU Session.

According to at least one of the Second Aspect and the variants in the Second Aspect, it can solve the above-mentioned problem.

For example, at least one of the Second Aspect and the variants in the Second Aspect can solve the problem that the above-mentioned service requirement has not been supported by the 5GS yet.

For example, at least one of the Second Aspect and the variants in the Second Aspect can solve the problem that there is no mechanism in the 3GPP specification(s) for achieving the above-mentioned service requirement.

For example, at least one of the Second Aspect and the variants in the Second Aspect can solve the problem that if the 5GS does not support the multi-path for indirect network connections, the Remote UE (or the remote UE) cannot avoid a sudden disruption or disconnection for any connectivity services over the indirect network connection due to unstable communication over single connection between the Remote UE and the Network Relay UE.

For example, at least one of the Second Aspect and the variants in the Second Aspect can solve the problem that user experience for the indirect network connection suffers from an unstable connection over single connection between the Remote UE and the Network Relay UE.

For example, according to at least one of the Second Aspect and the variants in the Second Aspect, the procedures for achieving the multi-path indirect network connections (e.g., the mPDU Session) are disclosed and the Remote UE can establish the multi-path indirect network connections. Therefore, it can solve the above-mentioned problem.

### (System Overview)

FIG. 9 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

For the telecommunication system 1 that supports Proximity based Services, the UE 3 may be separated into two different logical nodes, e.g., a Network Relay UE 300 and a Remote UE 310. While the Network Relay UE 300 is connected to the core network 7 via the (R)AN node 5, the Remote UE 310 is connected to the core network 7 via the Network Relay UE 300 and the (R)AN node 5. In one example, the Remote UE 310 is connected to the core network 7 via only the (R)AN node 5.

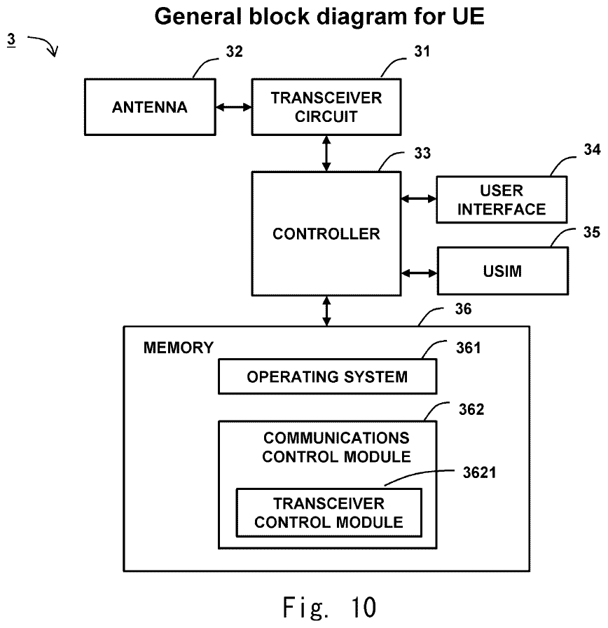

The block diagram for UE 3 in FIG. 10 may apply to the Network Relay UE 300, the Network Relay UE 30001, the Network Relay UE 30002, the Network Relay UE 30003 and the Remote UE 310.

The core network 7 also includes, amongst others, a Session Management Function (SMF) 71, a User Plane Function (UPF) 72, a Policy Control Function (PCF) 73, a Network Data Analytics Function (NWDAF) 74, a Unified Data Management (UDM) 75, and a Network Slice Selection Function (NSSF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type. The data network may include an Application Function (AF) 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.

RRC Setup Request message: This message is sent from the UE 3 to the (R)AN node 5. In addition to the parameters that are disclosed by Aspects in this disclosure, following parameters may be included together in the RRC Setup Request message.

#establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.

#masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.

#guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.

#5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message. #5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.

Registration Complete message: This message is sent from the UE 3 to the AMF 70. In addition to the parameters that are disclosed by Aspects in this disclosure, following parameters may be included together in the Registration Complete message.

#SOR transparent container.

Authentication Request message: This message is sent from the AMF 70 to the UE 3. In addition to the parameters that are disclosed by Aspects in this disclosure, following parameters may be included together in the Authentication Request message.

0 #ngKSI, ABBA, Authentication parameter RAND (5G authentication challenge), Authentication parameter AUTN (5G authentication challenge) and EAP message.

Authentication Response message: This message is sent from the UE 3 to the AMF 70. In addition to the parameters that are disclosed by Aspects in this 25 disclosure, following parameters may be populated together in the Authentication Response message.

#Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.

#ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.

#Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.

EAP message.
Service Request message: This message is sent from the UE 3 to the AMF 70. In addition to the parameters that are disclosed by Aspects in this disclosure, following parameters may be populated together in the Service Request message. #ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message. #PDU session status, PDU session reactivation result, PDU session reactivation result error cause, EAP message and T3448 value.

Service Reject message: This message is sent from the AMF 70 to the UE 3. In addition to the parameters that are disclosed by Aspects in this disclosure, following parameters may be populated together in the Service Reject message. #5GMM cause, PDU session status, T3346 value, EAP message, T3448 value and CAG information list.

Configuration Update Command message: This message is sent from the AMF 70 to the UE 3. In addition to the parameters that are disclosed by Aspects in this disclosure, following parameters may be populated together in the Configuration Update Command message.

#Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.

#Configuration update complete message identity.

### (User Equipment (UE))

FIG. 10 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in FIG. 10, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN). The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

the UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IOT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IOT UE (NB-IOT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

((R)AN node)

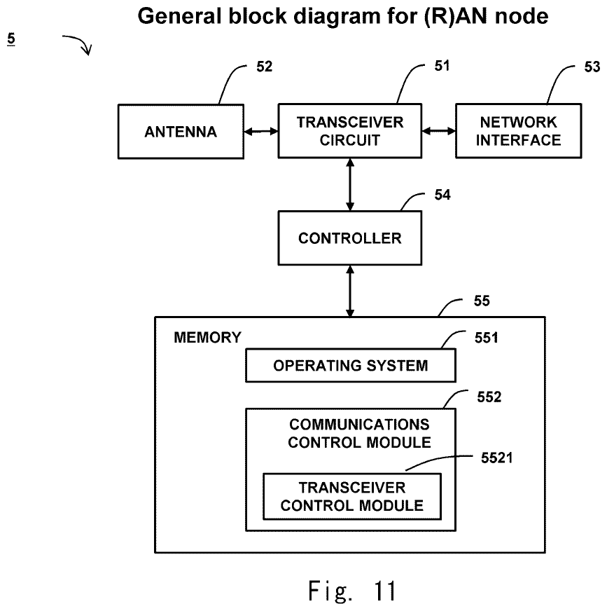

FIG. 11 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN). The NPN may be a Stand-alone Non-Public Network (SNPN) or a Public Network Integrated NPN (PNI-NPN).

The RAN 501, the RAN 502 and the RAN 503 may have same components to the (R)AN node 5. The (R)AN node 5 may be expressed as a RAN node, RAN, (R)AN etc.

### (System Overview of (R)AN Node 5 Based on O-RAN Architecture)

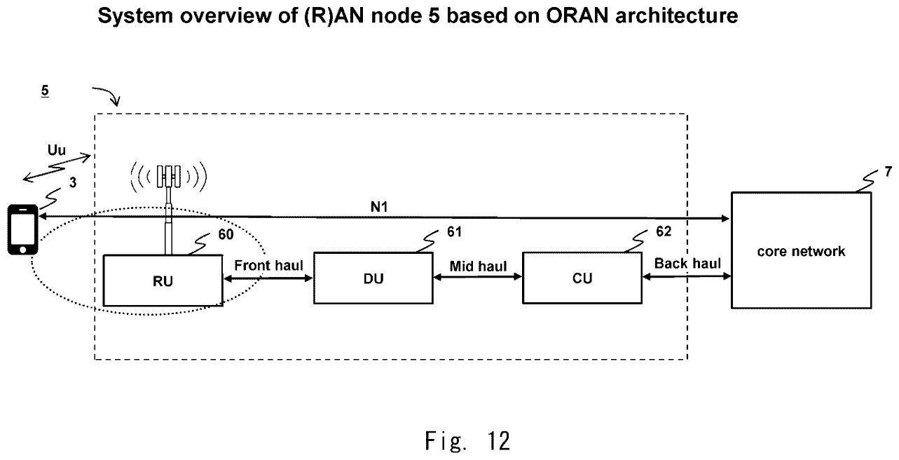

FIG. 12 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 (e.g., the Network Relay UE 300) over air interface, the DU 61 may provide functionalities to support MAC layer and RLC layer, the CU 62 may provide functionalities to support PDCP layer, SDAP layer and RRC layer.

### (Radio Unit (RU))

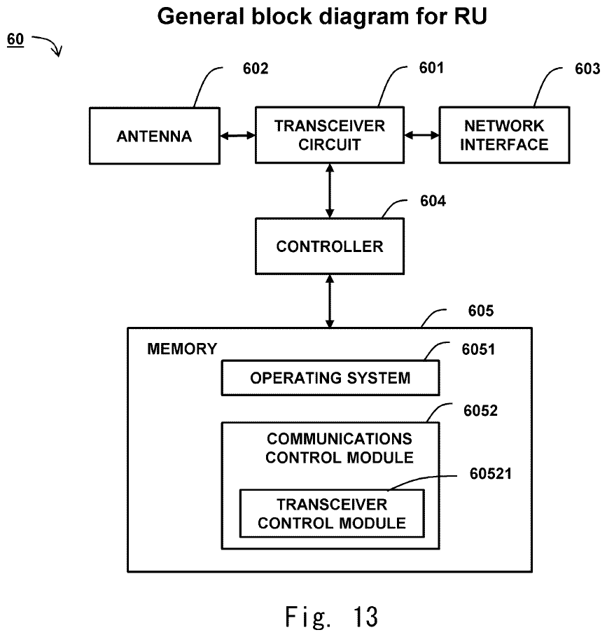

FIG. 13 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3 (e.g., the Network Relay UE 300)), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### (Distributed Unit (DU))

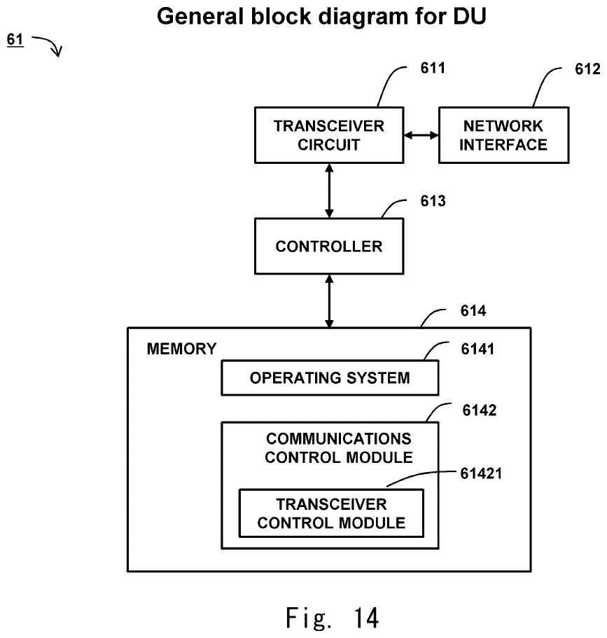

FIG. 14 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### (Centralized Unit (CU))

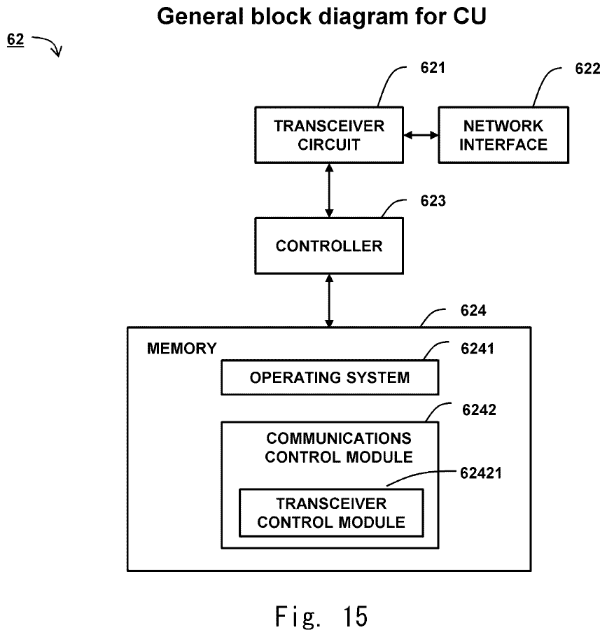

FIG. 15 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN). The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### (AMF)

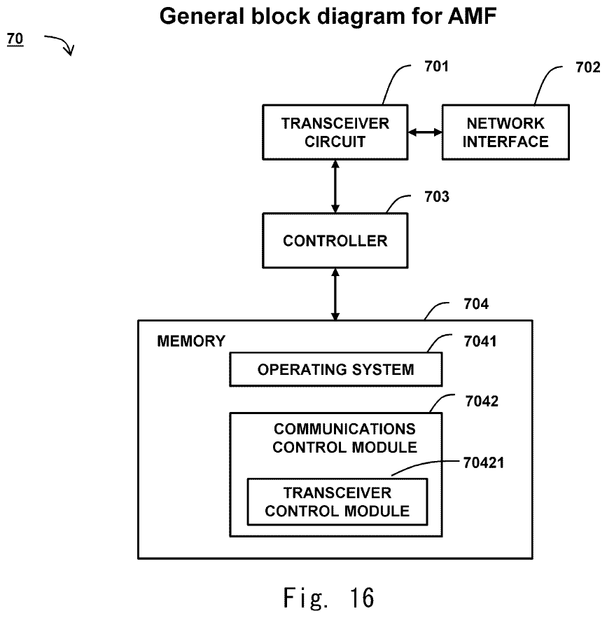

FIG. 16 is a block diagram illustrating the main components of the AMF 70. As shown, the apparatus includes a transceiver circuit 701 which is operable to transmit signals to and to receive signals from other nodes (including the UE 3 (e.g., the Network Relay UE 300 and the Remote UE 310), the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN). The NPN may be a Stand-alone Non-Public Network (SNPN) or a Public Network Integrated NPN (PNI-NPN).

### (SMF)

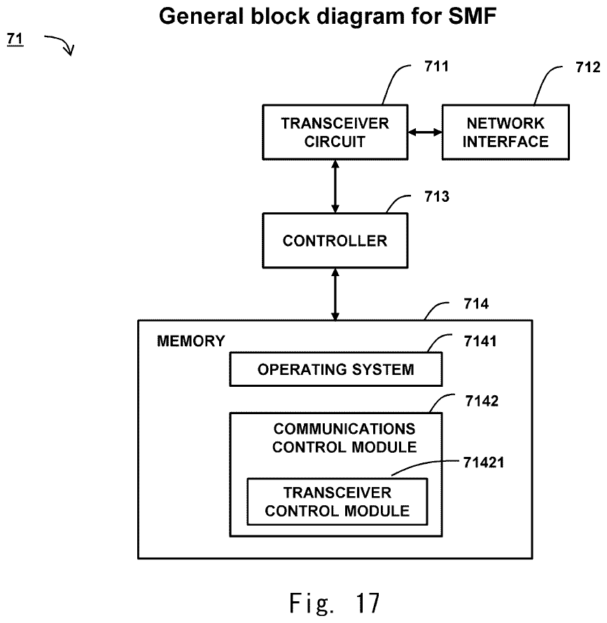

FIG. 17 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable data storage device (e.g. a removable memory device (RMD)), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the AMF 70 and other core network nodes (including core network nodes in the HPLMN of the UE 3 (e.g., the Network Relay UE 300 and the Remote UE 310) when the UE 3 is roaming-in. Such signalling may include, for example, appropriately formatted signalling messages (e.g. HTTP restful methods based on the service based interfaces) relating to policy management procedures (for the UE 3).

The SMF 71 may support the Non-Public Network (NPN). The NPN may be a Stand-alone Non-Public Network (SNPN) or a Public Network Integrated NPN (PNI-NPN).

### (UPF)

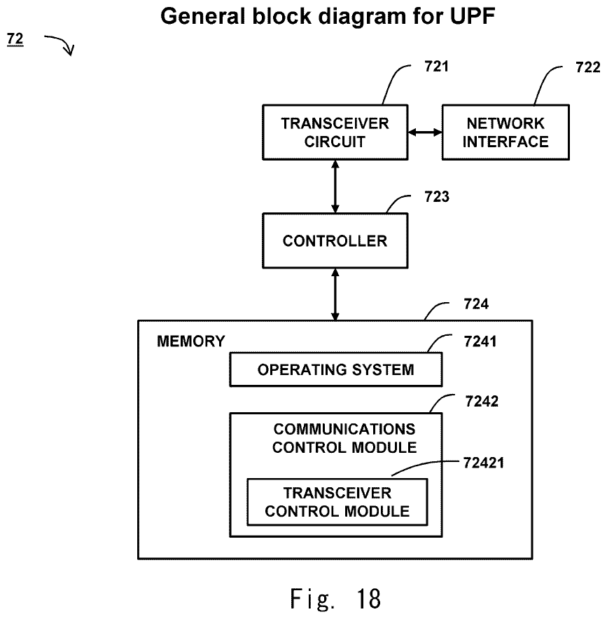

FIG. 18 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 (e.g., the Network Relay UE 300 and the Remote UE 310) when the UE 3 is roaming-in. Such signalling may include, for example, appropriately formatted signalling messages (e.g. a HTTP restful methods based on the service based interfaces) relating to policy management procedures (for the UE 3).

The UPF 72 may support the Non-Public Network (NPN). The NPN may be a Stand-alone Non-Public Network (SNPN) or a Public Network Integrated NPN (PNI-NPN). The UPF 72001 and the UPF 72002, the UPF 72003 and the UPF 72004 may have same components to the UPF 72.

### (PCF)

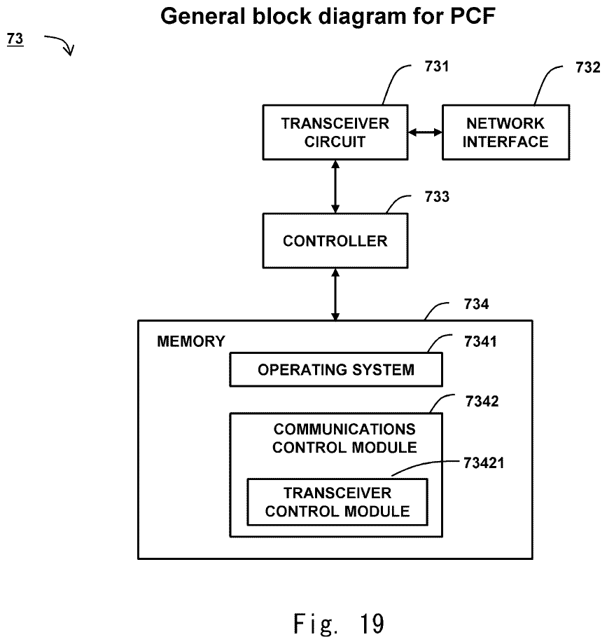

FIG. 19 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 (e.g., the Network Relay UE 300 and the Remote UE 310) when the UE 3 is roaming-in. Such signalling may include, for example, appropriately formatted signalling messages (e.g. HTTP restful methods based on the service based interfaces) relating to policy management procedures (for the UE 3).

The PCF 73 may support the Non-Public Network (NPN). The NPN may be a Stand-alone Non-Public Network (SNPN) or a Public Network Integrated NPN

### (PNI-NPN).

### (AF)

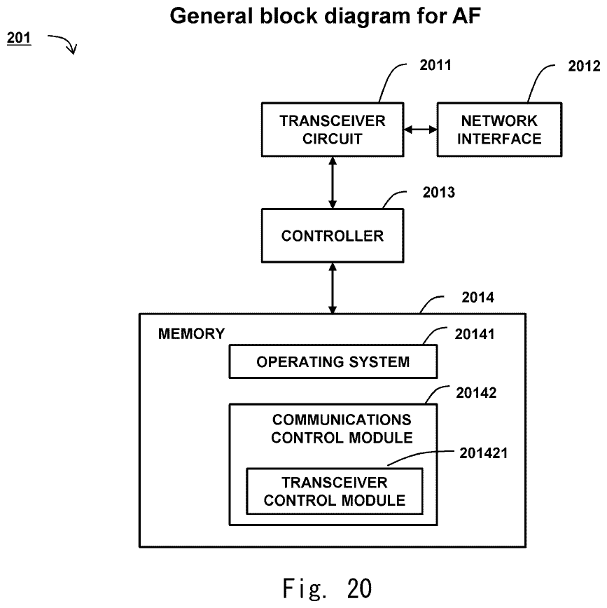

FIG. 20 is a block diagram illustrating the main components of the AF 201. As shown, the apparatus includes a transceiver circuit 2011 which is operable to transmit signals to and to receive signals from other nodes (including the UE 3 (e.g., the Network Relay UE 300 and the Remote UE 310)) via a network interface 2012. A controller 2013 controls the operation of the AF 201 in accordance with software stored in a memory 2014. Software may be pre-installed in the memory 2014 and/or may be downloaded via the telecommunication network or from a removable data storage device (e.g. a removable memory device (RMD)), for example. The software includes, among other things, an operating system 20141 and a communications control module 20142 having at least a transceiver control module 201421. The communications control module 20142 (using its transceiver control module 201421 is responsible for handling (generating/sending/receiving) signalling between the AF 201 and other nodes, such as the UE 3 and other core network nodes (including core network nodes in the HPLMN of the UE 3 when the UE 3 is roaming-in. Such signalling may include, for example, appropriately formatted signalling messages (e.g. HTTP restful methods based on the service based interfaces) relating to policy management procedures (for the UE 3). The AF 201 may support the Non-Public Network (NPN). The NPN may be a Stand-alone Non-Public Network (SNPN) or a Public Network Integrated NPN

### (PNI-NPN).

### (UDM)

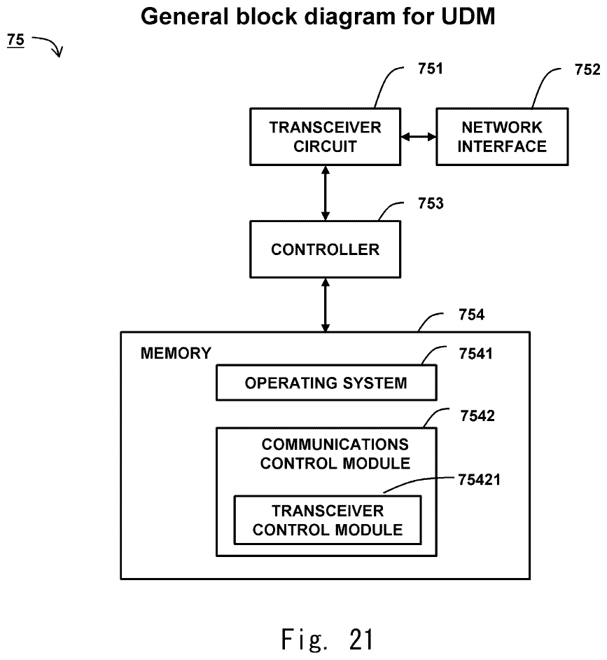

FIG. 21 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 (e.g., the Network Relay UE 300 and the Remote UE 310) when the UE 3 is roaming-out. Such signalling may include, for example, appropriately formatted signalling messages (e.g. HTTP restful methods based on the service based interfaces) relating to mobility management procedures (for the UE 3).

The UDM 75 may support the Non-Public Network (NPN). The NPN may be a Stand-alone Non-Public Network (SNPN) or a Public Network Integrated NPN

### (PNI-NPN).

The whole or part of the example Aspects disclosed above can be described as, but not limited to, the following.

### (Modifications and Alternatives)

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions, hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network.

For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

(Supplementary notes)

The whole or part of the example Aspects disclosed above can be described as, but not limited to, the following supplementary notes.

### (Supplementary Note 1)

A method of a Remote User Equipment (UE) comprising:
performing a registration procedure; and
performing a Protocol Data Unit (PDU) Session establishment procedure via a first ProSe UE-to-Network Relay and a PDU Session establishment procedure via a second ProSe UE-to-Network Relay.

### (Supplementary Note 2)

The method according to supplementary note 1, further comprising: receiving information for controlling communication via the first ProSe UE-to-Network Relay and via the second ProSe UE-to-Network Relay; and controlling the communication based on the information.

### (Supplementary Note 3)

The method according to supplementary note 2, wherein the information includes information for swapping an Internet Protocol (IP) address for the communication.

### (Supplementary Note 4)

The method according to supplementary note 2, further comprising: sending a PDU Session Identity (ID) for the communication and an IP address for the communication.

### (Supplementary Note 5)

The method according to any one of supplementary notes 2 to 4, further comprising:
receiving information indicating that the Remote UE is allowed to perform the communication.

### (Supplementary Note 6)

The method according to any one of supplementary notes 2 to 5, further comprising:
sending information indicating that the Remote UE requests the communication.

### (Supplementary Note 7)

The method according to supplementary note 6, further comprising: receiving information indicating that a network accepts the communication requested by the Remote UE.

### (Supplementary Note 8)

The method according to any one of supplementary notes 1 to 7, further comprising:
sending information indicating that the Remote UE supports connection via the first ProSe UE-to-Network Relay and connection via the second ProSe UE-to-Network Relay.

### (Supplementary Note 9)

A method of a first communication apparatus comprising:
receiving information indicating that a Remote User Equipment (UE) supports connection via a first ProSe UE-to-Network Relay and connection via a second ProSe UE-to-Network Relay; and
sending information indicating that the Remote UE is allowed to perform communication via the first ProSe UE-to-Network Relay and via the second ProSe UE-to-Network Relay.

### (Supplementary Note 10)

The method according to supplementary note 9, further comprising: receiving information indicating that the Remote UE requests the communication;
selecting a second communication apparatus;
sending the information to the second communication apparatus;
receiving information for controlling the communication and information indicating that a network accepts the communication requested by the Remote UE; and
sending the information for controlling the communication and the information indicating that the network accepts the communication requested by the Remote UE.

### (Supplementary Note 11)

The method according to supplementary note 10, further comprising: receiving a Protocol Data Unit (PDU) Session Identity (ID) for the communication and an Internet Protocol (IP) address for the communication; and
sending the PDU Session ID and the IP address to the second communication apparatus.

### (Supplementary Note 12)

A method of a first communication apparatus comprising:
communicating with a second communication apparatus; and
sending, to the second communication apparatus, information indicating that a Remote User Equipment (UE) is allowed to perform communication via a first ProSe UE-to-Network Relay and via a second ProSe UE-to-Network Relay.

### (Supplementary Note 13)

A method of a first communication apparatus comprising:

receiving, from a second communication apparatus, information indicating that a Remote User Equipment (UE) requests communication via a first ProSe UE-to-Network Relay and via a second ProSe UE-to-Network Relay; and
sending information for controlling the communication to the second communication apparatus.

### (Supplementary Note 14)

The method according to supplementary note 13, further comprising: sending, to a third communication apparatus, the information indicating that the Remote UE requests the communication via the first ProSe UE-to-Network Relay and via the second ProSe UE-to-Network Relay; and
receiving, from the third communication apparatus, information indicating that the Remote UE is allowed to establish the communication.

### (Supplementary Note 15)

The method according to supplementary note 13 or 14, further comprising:
sending, to a fourth communication apparatus, the information indicating that the Remote UE requests the communication via the first ProSe UE-to-Network Relay and via the second ProSe UE-to-Network Relay and information indicating that the first communication apparatus supports the communication; and
receiving, from the fourth communication apparatus, a policy including the information indicating that the Remote UE is allowed to establish the communication.

### (Supplementary Note 16)

The method according to any one of supplementary notes 13 to 15, further comprising:
sending, to a fifth communication apparatus, the information indicating that the Remote UE requests the communication via the first ProSe UE-to-Network Relay and via the second ProSe UE-to-Network Relay and the information for controlling the communication.

### (Supplementary Note 17)

A method of a first communication apparatus comprising:
receiving information for controlling communication via a first ProSe UE-to-Network Relay and via a second ProSe UE-to-Network Relay; and
performing the communication based on the information.

### (Supplementary Note 18)

A method of a first communication apparatus comprising:
receiving, from a second communication apparatus, information indicating that a Remote User Equipment (UE) requests communication via a first ProSe UE-to-Network Relay and via a second ProSe UE-to-Network Relay; and
sending, to the second communication apparatus, information indicating that the Remote UE is allowed to establish the communication.

### (Supplementary Note 19)

A method of a first communication apparatus comprising:
receiving, from a second communication apparatus, information indicating that a Remote User Equipment (UE) requests communication via a first ProSe UE-to-Network Relay and via a second ProSe UE-to-Network Relay and information indicating that the second communication apparatus supports the communication; and
sending, to the second communication apparatus, a policy including information indicating that the Remote UE is allowed to establish the communication.

### (Supplementary Note 20)

A Remote User Equipment (UE) comprising:
means for performing a registration procedure; and
means for performing a Protocol Data Unit (PDU) Session establishment procedure via a first ProSe UE-to-Network Relay and a PDU Session establishment procedure via a second ProSe UE-to-Network Relay.

### (Supplementary Note 21)

The Remote UE according to supplementary note 20, further comprising:
means for receiving information for controlling communication via the first ProSe UE-to-Network Relay and via the second ProSe UE-to-Network Relay; and
means for controlling the communication based on the information.

### (Supplementary Note 22)

The Remote UE according to supplementary note 21,
wherein the information includes information for swapping an Internet Protocol (IP) address for the communication.

### (Supplementary Note 23)

The Remote UE according to supplementary note 21, further comprising:
means for sending a PDU Session Identity (ID) for the communication and an IP address for the communication.

### (Supplementary Note 24)

The Remote UE according to any one of supplementary notes 21 to 23, further comprising:
means for receiving information indicating that the Remote UE is allowed to perform the communication.

### (Supplementary Note 25)

The Remote UE according to any one of supplementary notes 21 to 24, further comprising:
means for sending information indicating that the Remote UE requests the communication.
   (Supplementary Note 26) The Remote UE according to supplementary note 25, further comprising:
means for receiving information indicating that a network accepts the communication requested by the Remote UE.

### (Supplementary Note 27)

The Remote UE according to any one of supplementary notes 20 to 26, further comprising:
means for sending information indicating that the Remote UE supports connection via the first ProSe UE-to-Network Relay and connection via the second ProSe UE-to-Network Relay.

### (Supplementary Note 28)

A first communication apparatus comprising:
means for receiving information indicating that a Remote User Equipment (UE) supports connection via a first ProSe UE-to-Network Relay and connection via a second ProSe UE-to-Network Relay; and
means for sending information indicating that the Remote UE is allowed to perform communication via the first ProSe UE-to-Network Relay and via the second ProSe UE-to-Network Relay.

### (Supplementary Note 29)

The first communication apparatus according to supplementary note 28, further comprising:
means for receiving information indicating that the Remote UE requests the communication;
means for selecting a second communication apparatus;
means for sending the information to the second communication apparatus;
means for receiving information for controlling the communication and information indicating that a network accepts the communication requested by the Remote UE; and
means for sending the information for controlling the communication and the information indicating that the network accepts the communication requested by the Remote UE.

### (Supplementary Note 30)

The first communication apparatus according to supplementary note 29, further comprising:
means for receiving a Protocol Data Unit (PDU) Session Identity (ID) for the communication and an Internet Protocol (IP) address for the communication; and
means for sending the PDU Session ID and the IP address to the second communication apparatus.

### (Supplementary Note 31)

A first communication apparatus comprising:
means for communicating with a second communication apparatus; and
means for sending, to the second communication apparatus, information indicating that a Remote User Equipment (UE) is allowed to perform communication via a first ProSe UE-to-Network Relay and via a second ProSe UE-to-Network Relay.

### (Supplementary Note 32)

A first communication apparatus comprising:
means for receiving, from a second communication apparatus, information indicating that a Remote User Equipment (UE) requests communication via a first ProSe UE-to-Network Relay and via a second ProSe UE-to-Network Relay; and
means for sending information for controlling the communication to the second communication apparatus.

### (Supplementary Note 33)

The first communication apparatus according to supplementary note 32, further comprising:
means for sending, to a third communication apparatus, the information indicating that the Remote UE requests the communication via the first ProSe UE-to-Network Relay and via the second ProSe UE-to-Network Relay; and
means for receiving, from the third communication apparatus, information indicating that the Remote UE is allowed to establish the communication.

### (Supplementary Note 34)

The first communication apparatus according to supplementary note 32 or 33, further comprising:
means for sending, to a fourth communication apparatus, the information indicating that the Remote UE requests the communication via the first ProSe UE-to-Network Relay and via the second ProSe UE-to-Network Relay and information indicating that the first communication apparatus supports the communication; and
means for receiving, from the fourth communication apparatus, a policy including the information indicating that the Remote UE is allowed to establish the communication.

### (Supplementary Note 35)

The first communication apparatus according to any one of supplementary notes 32 to 34, further comprising:
means for sending, to a fifth communication apparatus, the information indicating that the Remote UE requests the communication via the first ProSe UE-to-Network Relay and via the second ProSe UE-to-Network Relay and the information for controlling the communication.

### (Supplementary Note 36)

A first communication apparatus comprising:
means for receiving information for controlling communication via a first ProSe UE-to-Network Relay and via a second ProSe UE-to-Network Relay; and
means for perform the communication based on the information.

### (Supplementary Note 37)

A first communication apparatus comprising:
means for receiving, from a second communication apparatus, information indicating that a Remote User Equipment (UE) requests communication via a first ProSe UE-to-Network Relay and via a second ProSe UE-to-Network Relay; and
means for sending, to the second communication apparatus, information indicating that the Remote UE is allowed to establish the communication.

### (Supplementary Note 38)

A first communication apparatus comprising:
means for receiving, from a second communication apparatus, information indicating that a Remote User Equipment (UE) requests communication via a first ProSe UE-to-Network Relay and via a second ProSe UE-to-Network Relay and information indicating that the second communication apparatus supports the communication; and
means for sending, to the second communication apparatus, a policy including information indicating that the Remote UE is allowed to establish the communication.

This application is based upon and claims the benefit of priority from Indian Patent Application number 202311030373, filed on Apr. 27, 2023, the disclosure of which is incorporated herein in its entirety by reference.

### REFERENCE SIGNS LIST

20 DATA NETWORK
201 AF
2011 TRANSCEIVER CIRCUIT
2012 NETWORK INTERFACE
2013 CONTROLLER
2014 MEMORY
20141 OPERATING SYSTEM
20142 COMMUNICATIONS CONTROL MODULE
201421 TRANSCEIVER CONTROL MODULE
3 UE
300 NETWORK RELAY UE
310 REMOTE UE
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
5 (R)AN NODE
51 TRANSCEIVER CIRCUIT
52 ANTENNA
53 NETWORK INTERFACE
54 CONTROLLER
55 MEMORY
55 OPERATING SYSTEM
552 COMMUNICATIONS CONTROL MODULE
5521 TRANSCEIVER CONTROL MODULE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
711 TRANSCEIVER CIRCUIT
712 NETWORK INTERFACE
713 CONTROLLER
714 MEMORY
7141 OPERATING SYSTEM
7142 COMMUNICATIONS CONTROL MODULE
71421 TRANSCEIVER CONTROL MODULE
72 UPF
721 TRANSCEIVER CIRCUIT
722 NETWORK INTERFACE
723 CONTROLLER
724 MEMORY
7241 OPERATING SYSTEM
7242 COMMUNICATIONS CONTROL MODULE
72421 TRANSCEIVER CONTROL MODULE
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 NWDAF
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NSSF

What is claimed is:

1-38. (canceled)

39. A method of a User Equipment (UE) comprising:
communicating with a communication apparatus; and
sending information to the communication apparatus,
wherein the information indicates that the UE supports communication via a plurality of Proximity based Services (ProSe) UE-to-Network Relays.

40. The method according to claim 39,
wherein the information is sent by a registration request message.

41. The method according to claim 39,
wherein the communication apparatus is an Access and Mobility Management Function (AMF).

42. A method of a communication apparatus comprising:
communicating with a User Equipment (UE); and
receiving information from the UE,
wherein the information indicates that the UE supports communication via a plurality of Proximity based Services (ProSe) UE-to-Network Relays.

43. The method according to claim 42,
wherein the information is received by a registration request message.

44. The method according to claim 42, further comprising:
receiving information related to the communication from another communication apparatus.

45. The method according to claim 44,
wherein the information related to the communication indicates that the UE is allowed to use the communication.

46. The method according to claim 44,
wherein the information related to the communication indicates that the UE is authorised to use the communication.

47. The method according to claim 44,
wherein the another communication apparatus is Unified Data Management (UDM).

48. The method according to claim 42,
wherein the communication apparatus is an Access and Mobility Management Function (AMF).

49. A User Equipment (UE) comprising:
at least one memory storing instructions; and
at least one processor configured to execute the instructions to:
send information to a communication apparatus,
wherein the information indicates that the UE supports communication via a plurality of Proximity based Services (ProSe) UE-to-Network Relays.

50. A communication apparatus comprising:
at least one memory storing instructions; and
at least one processor configured to execute the instructions to:
receive information from a User Equipment (UE),
wherein the information indicates that the UE supports communication via a plurality of Proximity based Services (ProSe) UE-to-Network Relays.
